(19) United States
(12) Patent Application Publication
(10) Pub. No.: US 2017/0118995 A1
(43) Pub. Date: May 4, 2017

(54) MINERAL FUNCTIONAL WATER, METHOD FOR PRODUCING THE SAME, AND METHOD FOR CONTROLLING UNICELLULAR ORGANISMS AND/OR VIRUSES

(71) Applicants: Riken Techno System Co., Ltd., Fukuoka (JP); Santa Mineral Co., Ltd., Tokyo (JP)

(72) Inventor: Koichi FURUSAKI, Fukuoka (JP)

(73) Assignees: Riken Techno System Co., Ltd.; Santa Mineral Co., Ltd.

(21) Appl. No.: 15/370,192

(22) Filed: Dec. 6, 2016

Related U.S. Application Data
(63) Continuation of application No. PCT/JP2015/076267, filed on Sep. 16, 2015.

(30) Foreign Application Priority Data
Sep. 17, 2014 (JP) 2014-189332
Sep. 17, 2014 (JP) 2014-189335

(51) Int. Cl. A01N 65/12; A01N 65/08; A01N 61/00; C02F 1/30; A01N 59/00; C02F 1/68; C02F 1/48; C02F 1/36; A01N 65/34; A01N 63/00

(52) U.S. Cl. CPC A01N 65/12; A01N 65/34; A01N 65/08; A01N 61/00; A01N 63/00; A01N 59/00; C02F 1/68; C02F 1/48; C02F 1/36; C02F 1/30

(57) ABSTRACT

Mineral functional water useful for controlling unicellular organisms and/or viruses is provided. The mineral functional water satisfies all of requirements (i), and (iii) and shows excellent controlling effects upon unicellular organisms and/or viruses. (i) In a sample wherein 15 pst·wt. or more of the mineral functional water is fixed with respect to 100 pst·wt. of a ceramic carrier, the average emissivity to black body at wavelength of 5 to 7 micrometers and wavelength of 14 to 24 micrometers (measurement temperature: 25 Centigrade) is 90% or more, (ii) pH of the mineral functional water is 12 or higher, and (iii) controlling effects against at least one of unicellular organisms and viruses are manifested.

### BACKGROUND OF THE INVENTION

1. Field of the Invention

The present invention relates to mineral functional water showing useful controlling effects upon unicellular organisms and/or vinises, producing method for the same, and variable application of the mineral functional water.

2. Description of the Related Art

Conventionally, preventing and treating of infectious disease caused by pathogenic unicellular organisms (e.g. Staphylococcus aureus, or the like) and/or viruses, have been important issues both in Japan and abroad.

For example, viruses which have high infectiosity to widely spread (e.g. influenza, or the like) and other viruses with high fatalities (e.g. Ebola hemorrhagic fever, or the like) have been reported.

In addition, also in livestock, serious damage of infectious disease caused by pathogenic unicellular organisms and/or viruses (e.g. Foot and Mouth disease, avian influenza, or the like) has been reported.

Foot and Mouth Disease is epidemic infectious disease that causes serious damage to the livestock, and in recent years has occurred even in Japan.

Since Foot and Mouth disease viruses have very strong infectivity, it is seriously difficult to prevent from propagation of Foot and Mouth disease.

Therefore, great efforts have been globally paid so as to perform prevention and medical treatment against Foot and Mouth disease.

Antiviral agents using vaccine have been developed as countermeasures against viruses. The vaccine, however, has its specificity. Unfortunately, a range from which the vaccine can prevent is limited to infection caused by a specific kind of viruses.

In some cases, mutation of viruses may cause conventional vaccine not to fully manifest effects thereof.

Therefore, it has been strongly desired to develop effective controlling composition against various kinds of viruses.

As mentioned above, there is a problem with respect to infectious disease caused by pathogenic unicellular organisms. Composition having excellent controlling effects against both unicellular organisms and viruses rarely exists. Such composition usually also has high toxicity to human and livestock.

It is supposed that mineral-containing water may show effects including: soil-modifying action; plant-growing action; harmful organic substance-decomposing action; deodorizing action; and air-cleaning action. Conventionally, various kinds of mineral-containing water and/or equipment for producing mineral-containing water have/have been developed.

The present inventors have developed a mineral-containing water-producing apparatus

(A) including:
a unit for immersing a conductive wire covered with insulator and mineral-imparting material (A) in water, conducting DC electric current to the conductive wire to generate water flow around the conductive wire in the same direction as the DC electric current, applying ultrasonic vibration to the water, thereby forming raw mineral water solution (A); and
a far-infrared ray-generating unit irradiating far-infrared rays to the formed raw mineral water solution (A) to produce mineral-containing water (A) (See, Reference 1.).

The present inventors also have developed mineral functional water-producing equipment including:
a mineral-containing water-producing apparatus (A);
a plurality of water-passing containers into which different kinds of mineral-imparting material (B) from each other is filled up;
a water supply passage communicating with the plurality of water-passing containers in series; and
a roundabout channel connected to the water supply passage in a state where the roundabout channel is parallel to the plurality of water-passing containers, respectively; and
a water stream-changing valve provided in branch pans between the water supply passage and the roundabout channel, respectively (See, Reference 2.).

The present inventors have also reported that upon using the mineral functional water-producing equipment, mineral functional water (far-infrared ray-generating water) with functions of generating far-infrared rays of specific wavelength can be produced.

### REFERENCES

Reference 1: Japan registered patent No. 4817817.

Reference 2: Japanese patent application Laid-open No. 2011-56366

### OBJECTS AND SUMMARY OF THE INVENTION

As mentioned above, various kinds of mineral-containing water have been reported in the past. Many of effects showed by mineral-containing water have not been scientifically proven, and true action of the mineral-containing water also has been not yet made clear in many respects.

In many cases, conventional mineral-containing water may not actually show advertised effects, may merely show effects which are insufficient for practical use, or, may has poor reproducibility of the effects.

With respect to even the mineral functional water produced using the device reported in Reference 2, it cannot be said that the target of the mineral functional water manifesting can surely be produced.

In particular, kinds and mixing ratios of material components (mineral-imparting material) used in the mineral-containing water-producing apparatuses (A) and (B) intricately concern. In fact, relationships between a kind of used mineral-imparting material and effects showed by obtained mineral functional water are not always proven.

In view of the above conditions, an object of the present invention is to provide mineral functional water capable of showing beneficial effects such as controlling action upon unicellular organisms and/or viruses.

Using the mineral functional water-producing equipment disclosed in Reference 2, the present inventors have repeated consideration mainly focusing on the kinds and the mixing ratios of mineral-imparting material.

Finally, the present inventors have found out that the mineral functional water produced under a certain specific condition manifests controlling effects upon unicellular organisms and/or viruses, thereby having devised the present invention.

That is, the present invention concerns the following mineral functional water.

Item [1]: Mineral functional water, comprising all of requirements (i), (ii), and (iii): (i) based on 100 pst·wt. of a ceramic carrier, in a sample in which 15 pst·wt. or more of the mineral functional water has been fixed, an average emissivity (measurement temperature: 25 Centigrade) to the black body is 90% or more between wavelengths of 5-7 micrometers and between wavelengths of 14-24 micrometers; (ii) pH of the mineral functional water is 12 or more and (iii) controlling effects upon at least one of unicellular organisms and viruses are showed.

The present invention also concerns a controlling method using the following mineral functional water.

Item [2]: A controlling method of applying the mineral functional water recited in Item 1 upon a target to be controlled including at least one of the unicellular organisms and the viruses.

Item [3]: The controlling method recited in Item 2, wherein the target of unicellular organisms to be controlled is at least one kind selected from a group consisting of Escherichia coli, Staphylococcus aureus, Bacillus subtilis, Pseudomonas aeruginosa, Candida, O-157, Mycoplasma, and Vibrio parahaemolyticus.

Item [4]: The controlling method recited in Item 2 or 3, wherein the target of viruses to be controlled is at least one kind selected from a group consisting of a non-enveloped RNA-type, an enveloped RNA-type, a non-enveloped DNA-type, and an enveloped DNA-type.

Item [5]: The controlling method recited in Item 2 or 3, wherein the target of viruses to be controlled is at least one kind selected from a group consisting of Foot and Mouth disease viruses, Bovine Rhinitis B viruses, parainfluenza in cattle viruses, bovine adenoviruses, and infectious bovine rhinotracheitis viruses.

Item [6]: The controlling method recited in Item 2 or 3, wherein the target of viruses to be controlled is at least one kind selected from a group consisting of influenza viruses, Ebola viruses, Foot and Mouth disease viruses, norovir uses, polio viruses, human immunodeficiency viruses, SARS coronaviruses, hepatitis A viruses, hepatitis C viruses, Rubella viruses, Measles viruses, Japanese encephalitis viruses, tick-borne encephalitis viruses, Rabies viruses, dengue viruses, arenaviruses, and Hantaviruses.

The present invention further concerns the following use of the mineral functional water.

Item [7]: A method of using the mineral functional water recited in Item 1 for controlling at least one of the unicellular organisms and the viruses.

The present invention further concerns the following composition containing the mineral functional water.

Item [8]: Composition for controlling unicellular organisms and/or viruses containing the mineral functional water recited in Item 1.

The present invention further concerns the following method of producing mineral function water.

Item [9]: A method of producing mineral function water, comprising: producing first mineral-containing water (A) according to the following first process (1): producing second mineral-containing water (B) according to the following second process (2): and mixing the first produced mineral-containing water (A) and the second produced mineral-containing water (B) according to a ratio within a range of 1:5-1:20 (weight ratio), wherein the first process (1) includes: immersing a conductive wire covered with insulator and mineral-imparting material (A) into water, the mineral-imparting material containing woody plant raw material and vegetation raw material, the vegetation raw material including: vegetation belonging to Asteraceae and vegetation belonging to Rosaceae, the woody plant raw material including at least one kind selected from a group consisting of Maple, Betula platyphylla, Pinus, and Cryptomeria japonica; conducting DC electric current to the conductive wire to generate water flow around the conductive wire in the same direction as the DC electric current, applying ultrasonic vibration to the water, thereby forming raw mineral water solution (A); and irradiating far-infrared rays (wavelength of 6-14 micrometers) to the raw mineral water solution (A) to form mineral-containing water (A), and wherein the second process (2) includes: filling up a water-passing container with inorganic mineral-imparting material (B) including 65 to 75 weight % of lime stone, 12 to 18 weight % of fossil coral, 12 to 18 weight % of shell, and 0.5 to 5 weight % of activated carbon, respectively; and making the water pass through the water-passing container to form mineral-containing water (B).

Item [10]: The method of producing mineral function water recited in Item 9, wherein: 10 to 15 weight % of the mineral-imparting material (A) based on the water is added; and the DC electric current conducted to the conductive wire has 0.05-0.1 A of a current value and 8000-8600 V of a voltage value, respectively.

Item [11]: The method of producing mineral function water recited in Item 9 or 10, wherein: the second process (2) further includes: connecting in series six water-passing containers of: a first water-passing container; a second water-passing container; a third water-passing container; a fourth water-passing container; a fifth water-passing container; and a sixth water-passing container to compose the water-passing container; filling up the six water-passing containers with inorganic mineral-imparting material (B) having different kinds from each other; and making the water pass through the six water-passing containers to form the mineral-containing water (B), wherein: the mineral-imparting material (B1) filled into the first water-passing container is mixture including: 65 to 75 weight % of lime stone; 12.5 to 17.5 weight % of fossil coral; and 12.5 to 17.5 weight % of shell, respectively; the mineral-imparting material (B2) filled into the second water-passing container is mixture including: 37 to 43 weight % of lime stone; 12.5 to 17.5 weight % of fossil coral; 37 to 43 weight % of shell, and 2.5 to 7.5 weight % of activated carbon respectively; the mineral-imparting material (B3) filled into the third water-passing container is mixture including: 75 to 85 weight % of lime stone; 12.5 to 17.5 weight % of fossil coral; and 2.5 to 7.5 weight % of shell, respectively; the mineral-imparting material (B4) filled into the fourth water-passing container is mixture including: 85 to 95 weight % of lime stone; 2.5 to 7.5 weight % of fossil coral; and 2.5 to 7.5 weight % of shell, respectively; the mineral-imparting material (B5) filled into the fifth water-passing container is mixture including: 75 to 85 weight % of lime stone; 7.5 to 12.5 weight % of fossil coral; and 7.5 to 12.5 weight % of shell, respectively; and the mineral-imparting material (B6) filled into the sixth water-passing container is mixture including: 55 to 65 weight % of lime stone; 27 to 33 weight % of fossil coral; and 7.5 to 12.5 weight % of shell, respectively.

Item [12]: The method of producing mineral function water recited in Item 11, wherein: the mineral-imparting material (B1) filled into the first water-passing container is mixture including: 70 weight % of lime stone; 15 weight % of fossil coral; and 15 weight % of shell, respectively; the mineral-imparting material (B2) filled into the second water-passing container is mixture including: 40 weight % of lime stone; 15 weight % of fossil coral; 40 weight % of shell; and 5 weight % of activated carbon, respectively; the mineral-imparting material (B3) filled into the third water-passing container is mixture including: 80 weight % of lime stone; 15 weight % of fossil coral; and 5 weight % of shell, respectively; the mineral-imparting material (B4) filled into the fourth water-passing container is mixture including: 90 weight ° A of lime stone; 5 weight % of fossil coral; and 5 weight % of shell, respectively; the mineral-imparting material (B5) filled into the fifth water-passing container is mixture including: 80 weight % of lime stone; 10 weight % of fossil coral; and 10 weight % of shell, respectively; and the mineral-imparting material (B6) filled into the sixth water-passing container is mixture including: 60 weight % of lime stone; 30 weight % of fossil coral; and 10 weight % of shell, respectively.

Item [13]: The method of producing mineral function water recited in any of Items 9 to 12, wherein: dried pulverized product of Asteraceae plants and dried pulverized product of Rosaceae plants are used as the mineral-imparting material (A); the dried pulverized product of the Asteraceae plants is produced by: mixing 8 to 12 weight % of Cirsium japonicum (leaf parts, stem parts and flower parts thereof), 55 to 65 weight % of Artemisia indica (leaf parts and stem parts thereof) and 27 to 33 weight % of Farfugium japonicum (leaf parts and stem parts thereof), respectively to produce first mixture thereof; making the first mixture dry; and then pulverizing the dried first mixture; the dried pulverized product of the Rosaceae plants is produced by: mixing 17 to 23 weight % of Rosa multiflora (leaf parts and flower parts thereof), 8 to 12 weight % of Geum japonicum (leaf parts and stem parts thereof), and 65 to 75 weight % of Rubors L. (leaf pans, stem parts, and flower parts thereof), respectively to produce second mixture thereof; making the second mixture dry; and then pulverizing the dried second mixture; the dried pulverized product of the Asteraceae plants and the dried pulverized product of the Rosaceae plants are mixed according to 1:0.8 to 1:1.2 (weight ratio) to obtain vegetation raw material (A1); the woody plant raw material (A2) is produced by: mixing 22 to 28 weight % of Maple (leaf parts and stem parts thereof), 22 to 28 weight % of Betula platyphylla (leaf parts, stem parts, and bark parts thereof), and 45 to 55 weight % of Cryptomeria japonica (leaf parts, stem parts, and bark parts thereof) to produce third mixture; making the third mixture dry; and then pulverizing the dried third mixture; and mineral-imparting material (A′) is obtained by mixing the vegetation raw material (A1) and the woody plant raw material (A2) according to 1:2.7 to 1:3.3 (weight ratio).

Item [14]: The method of producing mineral function water recited in Item 13, wherein the first produced mineral-containing water (A) and the second produced mineral-containing water (B) are mixed according to a ratio within a range of 1:7-1:12 (weight ratio).

The present invention further concerns the following method of controlling a barn.

Item [15]: A method of controlling a barn, comprising: spraying the mineral functional water recited in Item 1 in a state of mist in a space of the barn.

Preferable Embodiments of the mineral functional water according to the present invention concern the first invention [X1] and the second invention [X2], each of which is a producing method as specified below.

The mineral functional water according to the second invention [X2] corresponds to mineral functional water in Example 1 mentioned later.

[X1]: Mineral function water, containing first mineral-containing water (A) produced according to the following first process (1): and second mineral-containing water (B) produced according to the following second process (2) according to a ratio within a range of 1:5-1:20 (weight ratio),

wherein the first process (1) includes: immersing a conductive wire covered with insulator and mineral-imparting material (A) into water, the mineral-imparting material containing woody plant raw material and vegetation raw material, the vegetation raw material including: vegetation belonging to Asteraceae and vegetation belonging to Rosaceae, the woody plant raw material including at least one kind selected from a group consisting of Maple, Betula platyphylla, Pinus, and Cryptotmria japonica; conducting DC electric current to the conductive wire to generate water flow around the conductive wire in the same direction as the DC electric current, applying ultrasonic vibration to the water, thereby forming raw mineral water solution (A); and irradiating far-infrared rays (wavelength of 6-14 micrometers) to the raw mineral water solution (A) to form mineral-containing water (A),

wherein: 10 to 15 weight % of the mineral-imparting material (A) based on the water is added; and the DC electric current conducted to the conductive wire has 0.05-0.1 A of a current value and 8000-8600 V of a voltage value, respectively, and

wherein: dried pulverized product of Asteraceae plants and dried pulverized product of Rosaceae plants are used as the mineral-imparting material (A); the dried pulverized product of the Asteraceae plants is produced by: mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture; the dried pulverized product of the Rosaceae plants is produced by: mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture; the dried pulverized product of the Asteraceae plants and the dried pulverized product of the Rosaceae plants are mixed according to 1:1 (weight ratio) to obtain vegetation raw material (A1); the woody plant raw material (A2) is produced by: mixing 25 weight % of Maple (leaf parts and stem parts thereof), 25 weight % of Betula platyphylla (leaf parts, stem parts, and bark parts thereof), and 50 weight % of Cryptomeria japonica to produce third mixture; making the third mixture dry; and then pulverizing the dried third mixture; and mineral-imparting material (A′) is obtained by mixing the vegetation raw material (A1) and the woody plant raw material (A2) according to 1:3 (weight ratio),

wherein the second process (2) includes: connecting in series six water-passing containers of: a first water-passing container; a second water-passing container; a third water-passing container; a fourth water-passing container; a fifth water-passing container; and a sixth water-passing container to compose the water-passing container; filling up the six water-passing containers with inorganic mineral-imparting material

(B) having different kinds from each other, and

wherein: the mineral-imparting material (B 1) filled into the first water-passing container is mixture including: 70 weight % of lime stone; 15 weight % of fossil coral; and 15 weight % of shell, respectively; the mineral-imparting material (B2) filled into the second water-passing container is mixture including: 40 weight % of lime stone; 15 weight % of fossil coral; 40 weight % of shell; and 5 weight % of activated carbon, respectively; the mineral-imparting material (B3) filled into the third water-passing container is mixture including: 80 weight % of lime stone; 15 weight % of fossil coral; and 5 weight % of shell, respectively; the mineral-imparting material (B4) filled into the fourth water-passing container is mixture including: 90 weight % of lime stone; 5 weight % of fossil coral; and 5 weight % of shell, respectively; the mineral-imparting material (B5) filled into the fifth water-passing container is mixture including: 80 weight % of lime stone; 10 weight % of fossil coral; and 10 weight % of shell, respectively; and the mineral-imparting material (B6) filled into the sixth water-passing container is mixture including: 60 weight % of lime stone; 30 weight % of fossil coral; and 10 weight % of shell, respectively.

[X2]: The mineral function water recited in the first invention [X1], wherein the first produced mineral-containing water (A) and the second produced mineral-containing water (B) are mixed according to a ratio of 1:10 (weight ratio).

### EFFECT OF INVENTION

According to the present invention, the mineral functional water with beneficial effects, such as controlling unicellular organisms and/or viruses can be provided.

### BRIEF DESCRIPTION OF THE DRAWINGS

FIG. 1 is a block diagram showing a schematic structure of mineral functional water-producing equipment;

FIG. 2 is a mimetic diagram of a mineral-containing water solution production unit configuring a part of mineral-containing water (A) producing apparatus that constitutes the mineral functional water-producing equipment shown in FIG. 1;

FIG. 3 is a partial sectional view of FIG. 2 according to the A-A line thereof;

FIG. 4 is a perspective view of a housing container of the mineral-imparting material (A) used for the raw mineral water solution production unit shown in FIG. 2;

FIG. 5 is a mimetic diagram showing a reaction state near a conductive wire in the raw mineral water solution production unit shown in FIG. 2;

FIG. 6 is a sectional view of far-infrared ray-irradiating apparatus configuring a part of the mineral-containing water (A) producing apparatus that constitutes the mineral functional water-producing equipment shown in FIG. 1;

FIG. 7 is a block diagram of mineral-containing water (B) producing apparatus that constitutes the mineral functional water-producing equipment shown in FIG. 1;

FIG. 8 is a front view showing the mineral-containing water (B) producing apparatus that constitutes the mineral functional water-producing equipment shown in FIG. 1;

FIG. 9 is a side view of the mineral-containing water (B) producing apparatus shown in FIG. 8;

FIG. 10 is a partial perspective view showing the structure of the mineral-containing water (B) producing apparatus shown in FIG. 8;

FIG. 11 is a side view of a water-passing container that constitutes the mineral-containing water (B) producing apparatus shown in FIG. 8;

FIG. 12 shows spectral radiation spectra of the black body (theoretical values) and a sample in Example 1 wherein 20 pst·wt. of mineral functional water in Example 1 is fixed based on 100 pst·wt. of ceramic carriers (measurement temperature: 25 Centigrade, range of wavelengths: 4-24 micrometers, carrier: ceramic powder);

FIG. 13 is a graph showing emissivity of a sample in Example 1 wherein 20 pst·wt. of the mineral functional water in Example 1 is fixed based on 100 pst·wt. of the ceramic carriers (measurement temperature: 25 Centigrade);

FIG. 14 is a mimetic diagram showing the principle of a hemagglutination activation method:

FIG. 15 shows a result of an influenza virus activity inhibitory test (hemagglutination activation method); and

FIG. 16 shows reference images in the influenza virus activity inhibitory test.

### BRIEF SPECIFICATION OF SYMBOLS

1: mineral functional water-producing equipment

2: mineral-containing water (A) producing apparatus

3: mineral-containing water (B) producing apparatus

10: raw mineral water solution production unit

11, W: water

12: mineral-imparting material (A)

13: reaction vessel

13a: wall body

14: insulator

15: conductive wire

16: ultrasonic wave generation unit

17: DC power supply device

18a, 18b, 18c: circulating passage

19: drain port

20, 23: opening control valve

21, 25: drain valve

22: housing tank

24: drain pipe

26: water temperature gage

29, 29a-29g, 29s, 29t: conductive cable

30: terminal

31: housing container

31f: hook

40: treatment container

41: raw mineral water solution (A)

42: agitation blade

43: far-infrared ray-generating unit

44: mineral-containing water (A)

45: mineral-containing water (B)

46: mixing tank

47: mineral functional water

51: first water-passing container

52: second water-passing container

53: third water-passing container

54: fourth water-passing container

55: fifth water-passing container

56: sixth water-passing container

51a-56a: main body part

51b-56b: switching button

51c-56c: axial center

51d-56d: lid body

51f-56f: flange part

51m-56m: mineral-imparting material (B)

51p-56p: roundabout channel

51v-56v: water stream-changing valve

57, 57x, 57y: water-supply passage

57a: water inlet

57b: water outlet

57c: mesh strainer

57d: automatic air valve

58: operation panel

59: signal cable

60: support frame

61: castor

62: level adjuster

63: raw water tank

DC: direct electric current

DW: tap water

R: water flow

### DETAILED DESCRIPTION OF THE PREFERRED EMBODIMENTS

Hereinafter, with reference to the accompanying drawings, the present invention will now be explained while adducing some examples. The present invention, however, is not limited to the examples, and may be arbitrarily modified and/or changed within the scope of the present invention.

In addition, in this specification, the symbol of “−” is used for expression that means containing values and/or physical quantity below and over thereof.

[1. Mineral Functional Water According to the Present Invention]

The mineral functional water according to the present invention satisfies all of requirements (i), (ii), and (iii):

(i) based on 100 pst·wt. of a ceramic carrier, in a sample in which 15 pst·wt. or more of the mineral functional water has been fixed, an average emissivity (measurement temperature: 25 Centigrade) to the black body is 90% or more between wavelengths of 5-7 micrometers and between wavelengths of 14-24 micrometers;

(ii) pH of the mineral functional water is 12 or more; and

(iii) controlling effects upon at least one of unicellular organisms and viruses are showed.

In this specification, “mineral functional water” means water that contains at least one mineral component to reveal at least one or more kind(s) of beneficial effects. Although details will be mentioned later, the mineral functional water according to the present invention has controlling effects upon at least one of unicellular organisms and vinises as the beneficial effects.

Furthermore, in this specification, “mineral-containing water” means raw material water at a preceding stage when producing the mineral functional water, and also contains at least one mineral component.

Details thereof will be described regarding a method of producing the mineral function water according to the present invention.

Note that the mineral-containing water itself may have the beneficial effect, or may not.

In this specification, the “mineral component” does not mean one of inorganic components, which include trace elements, defined in a narrow sense except the 4 Elements of carbon, hydrogen, nitrogen, and oxygen.

As long as co-existing with the inorganic components, the “mineral component” may contain at least one of the 4 Elements of carbon, hydrogen, nitrogen, and oxygen which are excluded in a narrow sense.

Therefore, for example, a “mineral component derived from plants” is a broad concept that includes not only at least one of inorganic components such as calcium derived from the plants but also at least one of organic components derived from the plants.

The inorganic component constituting the mineral component may be sodium, potassium, calcium, magnesium, phosphorus, or the like. And, the trace element may be iron, zinc, copper, manganese, iodine, selenium, chromium, molybdenum, or the like. However, neither the inorganic component nor the trace element is limited to these elements.

Hereinafter, the mineral functional water according to the present invention will now be explained in more detail.

The raw material of the mineral functional water according to the present invention and a method for producing the same will be later explained in paragraphs related to [3. Method of producing mineral function water according to the present invention].

The mineral functional water “CAC-717” produced by Riken techno system Co., LTD. can be adduced as preferable mineral functional water satisfying all the above-mentioned requirements (i), (ii), and (iii).

Requirement (i)

The mineral functional water according to the present invention requires that (i) wherein based on 100 pst·wt. of a ceramic carrier, in a sample in which 15 pst·wt. (preferably 20 pst·wt.) or more of the mineral functional water has been fixed, an average emissivity (measurement temperature: 25 Centigrade) to the black body is 90% or more between wavelengths of 5-7 micrometers and between wavelengths of 14-24 micrometers.

In this specification, “emissivity” is a ratio of the sample radiant emittance of a sample radiant surface to the base radiant emittance of the black body at the same temperature (JIS Z 8117), and “spectral emissivity” indicates percentage of the sample radiant emittance when the base radiant emittance of the black body is assumed to be 100%.

The evaluated sample has a specific spectral radiation spectrum.

The “black body” absorbs 100% of the entering light, and has the greatest energy radiation power. Theoretically, nothing can have energy radiation power more than the black body.

JIS R 180 has defined a measuring method of spectral radiation spectra. Measurement thereof can be made utilizing an emissivity-measuring system including equipment configuration in accordance with JIS R 180 using Fourier transform infrared spectroscopy (FTIR).

The far-infrared ray-radiating ratio-measuring apparatus (JIR-E500) produced by JEOL Ltd. can be adduced as a preferable example of the emissivity-measuring system.

It is difficult to directly measure the spectral emissivity of a liquid sample. Therefore, measurement thereof is normally performed using a method of fixing the sample onto a reference carrier.

The spectral radiation spectrum of the mineral functional water according to the present invention is measured while having fixed the mineral functional water onto ceramic powder for carrying thereof.

Details of the measurement will be explained later in paragraphs related to Examples.

Radial rays having wavelengths of 5-7 or 14-24 micrometers to the black body (at 25 Centigrade) correspond to intermediate-infrared rays. The intermediate-infrared rays have: less photon energy; stronger penetration power than near-infrared rays; and properties of reaching even inner portions of living body.

In an emissivity profile to the black body (at 25 Centigrade), values between the wavelengths of 5-7 micrometers and 14-24 micrometers are added to calculate an average value thereof to the black body (at 25 Centigrade), thereby determining the average value as average emissivity. Herein, the average emissivity of the mineral functional water according to the present invention is 90% or more.

Namely, the function water according to the present invention has a possibility of showing beneficial effects caused by the intermediate-infrared rays.

Requirement (ii)

The mineral functional water according to the present invention requires that (ii) pH of the mineral functional water is 12 or more.

pH of the mineral functional water according to the present invention is numerical expression of pH obtained by measuring the mineral functional water with a pH meter.

Herein, the pH meter is not limited to what is shown in Examples.

The mineral functional water according to the present invention has little fluctuation of pH and can keep an alkaline state.

Why the mineral functional water according to the present invention has little fluctuation of pH and can maintain the alkaline state is not clear in details now. As explained in the estimation mechanism mentioned later, there is a possibility that a complex of calcium and carbon derived from vegetation and/or woody plants contained in raw material has a role of pH buffer to control the fluctuation of pH.

Strong alkali (pH 12 or more) normally corrodes protein forming cell membrane and has risk of such as irritation and/or toxicity due to chemical action caused by solute ions of the alkali.

Although the mineral functional water is alkaline, it possesses properties that have excellent safety for both human and animals.

The mineral functional water according to the present invention has no toxicity which conventional disinfectant possesses to cause no problem when it is sucked and/or adhered to skin. Accordingly, protective tools, such as a rubber glove, a goggle, and a mask are not needed.

Requirement (iii)

The mineral functional water according to the present invention requires that (iii) controlling effects upon at least one of unicellular organisms and viruses are showed. The mineral functional water according to the present invention disclosed in Examples is experimentally proven that controlling effects thereof upon both unicellular organisms and viruses are showed.

Target unicellular organisms and viruses will be described later in paragraphs related to [2. Usage of the Mineral Functional Water According to the Present Invention].

Why the mineral-containing water according to the present invention reveals controlling effects upon unicellular organisms and/or viruses has been not yet made clear in many respects. An estimation mechanism related thereto, however, will now be explained.

Firstly, there is a possibility that mineral components contained in the mineral functional water according to the present invention form a special structure.

As indirect evidence, estimation has been performed by: drying the mineral functional water according to the present invention to precipitate mineral components therefrom; and observing the precipitated mineral components with an electron microscope. The result of the estimation suggests that structures in a Meso-Scale (hereinafter called as a “Meso structure”) are formed in the precipitated components.

Herein, the mineral components obtained are composed of collected crystalline material.

As above-mentioned, the mineral functional water according to the present invention can keep the strong alkaline state (pH 12 or more) without using any stimulative chemical agent, such as caustic soda.

This may be based on direct discharge action to the water caused by the Meso structure fine particle of the mineral components distributed in the water.

In a case of pH 12, alkaline hydrolysis may loosen bond (peptide bond) of protein forming cell membrane of unicellular organisms and/or viruses, electromagnetic waves radiated from the mineral components may act thereon, and there is a possibility of showing the controlling effects upon the unicellular organisms and/or the viruses synergistically.

In other words, at least a part of the mineral components contained in the mineral functional water according to the present invention has a high possibility of containing a mineral component of a Meso structure fine particle.

Although the details of the above are not completely clear, it is guessed that at least a part of the mineral components are distributed in the functional water not as water-soluble components but as insoluble fine particles (Meso structure fine particles) so as to show the action of the functional water according to the present invention.

It is guessed that the Meso structure fine particles, which are composed of collected crystalline material, are particles having: a particle diameter of about 50-500 nanometers; a self power-generating capacity of negative potential based on free electron capture in the structure thereof; hydrogen occlusion action; and also terahertz electromagnetic wave-generating capability

The Meso structure fine particles can continuously generate high voltage in a state of pulses, and discharge to the surrounding water molecules contacting there-with, thereby decomposing the water molecules into H⁺ ions and OH⁻ ions through electrolysis.

The Meso structure fine particles have physical properties of: the negative potential; and the hydrogen occlusion action. Therefore, the Meso structure fine particles give electrons to the H⁺ ions to change them to hydrogen (H) atoms. And then, the hydrogen atoms are accumulated in the inside of the Meso structure fine particles to be fixed therein.

Due to this, it is guessed that the H⁺ ions are relatively decreased in number so as to keep the strong alkali state (pH 12 or more).

In some cases, time of preservation and/or use environment may cause pH fluctuation of general strong alkali solution in which basic compounds are dissolved.

The mineral functional water according to the present invention controls terahertz wavelengths caused by pulse electric fields of the Meso structure fine particles within wavelengths sympathizing with vibration movement acting on the deoxidization of water, thereby enabling long term stability of the strong alkaline state (pH 12 or more).

As mentioned later in Examples with respect to mechanism of controlling viruses, the mineral functional water acts up to genomes in the inside of viruses so as to destroy them.

The estimation mechanism mentioned above has been merely made according to the present knowledge. Even if mechanisms differing from the above will be discovered in the future, the beneficial effects of the mineral functional water according to the present invention should NEVER be restrictively interpreted thereby.

The mineral functional water according to the present invention may show a plurality of useful effects differing from each other, and mechanisms thereof may also be different.

(Other Components)

The mineral functional water according to the present invention may be diluted with preferable dilute solvents (water, alcohol, or the like) within a range wherein the object according to the present invention is not spoiled.

Optional components may be contained in the mineral functional water according to the present invention within a range wherein the effects thereof is not spoiled.

The optional components are not limited within the range wherein the object according to the present invention is not spoiled. Known suspension, emulsion, or the like may be used, for example.

A mixing ratio thereof is optional within the range wherein the object according to the present invention is not spoiled.

Upon using the mineral functional water according to the present invention for washing, known detergent may be used by mixture.

A mixing ratio thereof is optional within the range wherein the object according to the present invention is not spoiled.

[2. Usage of the Mineral Functional Water According to the Present Invention]

The mineral functional water according to the present has controlling effects upon at least one of unicellular organisms and viruses.

Hereinafter, cases where the mineral functional water according to the present invention is used for: controlling unicellular organisms; and controlling viruses will now be explained.

The mineral functional water according to the present invention is applicable to the following usage while utilizing the controlling effects upon unicellular organisms and viruses:

(2-1a) A controlling method of applying the mineral functional water according to the present invention upon unicellular organisms and/or vinises;

(2-1b) A method of using the mineral functional water according to the present invention for controlling unicellular organisms and/or viruses; and

(2-2) Composition for controlling unicellular organisms and/or viruses containing the mineral functional water according to the present invention.

In this specification, “unicellular organisms” are a concept including bacteria, funguses, protozoa, or the like.

The unicellular organisms, which are the target to be controlled with the mineral functional water according to the present invention, are not limited as long as they are unicellular pathogenic bacteria (such as bacteria, funguses, and protozoa) which can be deactivated (killed) due to the action caused by components contained in the mineral functional water according to the present invention.

At least one kind selected from a group consisting of Escherichia coli, Staphylococcus aureus, Bacillus subtilis, Pseudomonas aeruginosa, Candida, O-157, Mycoplasma, and Vibrio parahaemolyticus can be adduced as preferable targets of unicellular organisms to be controlled.

In this specification, “controlling effects upon unicellular organisms” means having at least one of action of killing the unicellular organisms and action of inhibiting the unicellular organisms.

As shown in Examples mentioned later, upon using the mineral functional water whose composition is well-prepared, especially unicellular organisms, such as Escherichia coli and Staphylococcus aureus, can be almost completely controlled in about one hour.

In this specification, a “virus” means a microstructure that has not a constitutional unit of a cell but a genome of either DNA or RNA, and that increases only within a host cell utilizing a metabolic system therein.

Herein, the virus may act as a pathogen to increase in the host cell, thereby resulting in causing illness therein called as “virus infectious disease”.

“Controlling effects upon viruses” means having at least one of action of inactivating the viruses and action of inhibiting the viruses.

Infection caused by the viruses includes steps I-VI of: I: “adsorption to a cell surface”; II: “invasion into the cell”; III: “threshing”; IV: “synthesis of virus parts, such as a viral genome and virus protein”; V: “assemblage of the virus parts”; and VI: “removing from the cell”.

Namely, composition for controlling viruses according to the present invention possesses inhibiting activity upon at least one of the above-mentioned steps I-VI.

The viruses, which are the target to be controlled with the mineral functional water according to the present invention, are not limited as long as they are viruses which can be deactivated (killed) due to the action caused by components contained in the mineral functional water according to the present invention.

The mineral functional water according to the present invention possesses controlling effect upon all of a non-enveloped RNA-type, an enveloped RNA-type, a non-enveloped DNA-type, and an enveloped DNA-type.

The controlling method using the mineral functional water according to the present invention can be applied for controlling optional types of viruses without limitation because of the type thereof.

At least one kind selected from a group consisting of influenza viruses, Ebola viruses, Foot and Mouth disease viruses, noroviruses, polio viruses, human immunodeficiency viruses, SARS coronaviruses, hepatitis A viruses, hepatitis C viruses, Rubella viruses, Measles viruses, Japanese encephalitis, tick borne encephalitis viruses, Rabies viruses, dengue viruses, arenaviruses can be adduced as preferable targets of viruses to be controlled.

With respect to infectious disease to livestock, at least one kind selected from a group consisting of Bovine Rhinitis B viruses, parainfluenza in cattle viruses, bovine adenoviruses, and infectious bovine rhinotracheitis viruses can be adduced as preferable targets of viruses to be controlled.

The mineral functional water according to the present invention is composed of characteristic components that possess not only the controlling effects upon viruses but also the controlling effects upon unicellular organisms, such as bacteria and funguses. In many cases, components with effects upon unicellular organisms, such as bacteria and funguses normally do not have the controlling effects upon viruses.

Therefore, it is supposed that working mechanism of the composition for controlling viruses according to the present invention is remarkably different from that of antibacterial agents, antifungal agents, or the like.

(2-1): A Method of Controlling Unicellular Organisms and/or Viruses

(2-1a) The controlling method of applying the mineral functional water according to the present invention upon unicellular organisms and/or viruses and (2-1b) the method of using the mineral functional water according to the present invention for controlling unicellular organisms and/or viruses have the same meaning, each of which hereinafter will be called as “the method of controlling unicellular organisms and/or viruses according to the present invention” or “the controlling method according to the present invention.”

The controlling method according to the present invention is characterized by applying an effective amount of the mineral functional water of the above-mentioned present invention upon a target to be controlled of unicellular organisms and/or viruses.

Since the mineral functional water according to the present invention has the controlling effects upon the unicellular organisms and viruses causing infectious illness of human and/or animals, it controls the unicellular organisms and the viruses utilizing the controlling effects.

“The effective amount (of the mineral functional water)” with respect to the controlling method according to the present invention means an amount that at least one of the inactivating action and the inhibiting action against the unicellular organisms and/or the viruses is manifested upon applying the amount of the mineral functional water according to the present invention to the target of the unicellular organisms and/or the viruses.

As one of features of the mineral functional water according to the present invention, it can be pointed out that not only immediately after having applied it to a habitat of the target to be controlled of the unicellular organisms and/or the viruses but also for a significant period, after that, controlling effects are maintained so that increase of the target to be controlled of the unicellular organisms and/or the viruses is not found.

The period for which controlling effects are maintained may change according to the kind of the target to be controlled of the unicellular organisms and/or the viruses and/or the applied amount of the mineral functional water thereto. tinder preferable conditions, the controlling effects within several days or about one week have been found.

The target of animals to be controlled using the controlling method according to the present invention include not only animals in livestock but also pets, such as dogs and cats. The method is, however, preferably applied to the animals in the livestock. There is no limitation regarding the livestock. For example, the livestock may include cattle, horses, pigs, sheep, goats, hens, or the like.

The controlling method according to the present invention is a controlling method of applying the water to the target to be controlled of the unicellular organisms and/or viruses, and is roughly divided into a method of directly applying the mineral functional water according to the present invention to human and/or animals, and a method of indirectly applying the mineral functional water according to the present invention to human and/or animals.

When directly or indirectly applying the mineral functional water according to the present invention to control the unicellular organisms and/or the viruses causing the infectiosity illness, the anxious infectious illness to human and/or the animals can be prevented.

Improvement and/or curative effects of the infectiosity illness can be also expected by controlling the unicellular organisms and/or the viruses.

Hereinafter, each of the methods in the controlling method according to the present invention will now be explained.

(Method of Directly Applying Mineral Functional Water)

A method of spraying the mineral functional water according to the present invention directly onto skin and/or membrane of human and/or animals, a method of directly applying the mineral functional water according to the present invention onto the same, or the like can be adduced as the method of directly making the mineral functional water according to the present invention act onto the same.

In this case, the mineral functional water according to the present invention is preferably used as liquid material.

According to the method, unicellular organisms and/or viruses on the skin and/or the membrane of human and/or animals can be controlled to perform fundamental infectious disease control measures.

Note that a method of washing the skin and/or the membrane utilizing the mineral functional water according to the present invention includes a method of directly making the same thereon.

In a case where the target is human, a method of spraying the same onto hands, legs, nails, or the like thereof to wash unicellular organisms and/or viruses, thereby killing and/or inactivating them is one of preferable methods.

Especially, upon using it in livestock, a method of spraying the mineral functional water according to the present invention in a manner such that a body surface of the livestock gets wet with the same is one of preferable methods.

A method of applying the same to parts liable to be infected with a sponge, and a method of making a puddle of the same in a cripple to immerse the legs therein are also effective.

As mentioned above, since the mineral functional water according to the present invention is safe, also after having sprayed the same in livestock, it is not necessary to wash it away. This is very beneficial.

(Method of Indirectly Applying Mineral Functional Water)

When the target is human, a method of contacting the mineral functional water according to the present invention with tools and/or material used by him/her, such as farm equipment, boots, work wears, or the like can be adduced as the method of indirectly making the mineral functional water according to the present invention act onto the same.

There is no limitation regarding how to contact with the mineral functional water according to the present invention. For example, sprinkling it, spraying it, applying it or the like can be adduced.

When the target is livestock, a method of contacting the mineral functional water according to the present invention with a habitat of the livestock and/or an accumulation place of garbage and/or excreta discharged therefrom can be adduced.

When the target is a pet, such as a dog, a cat, or the like, the tools and/or the material used for the pet, and toys and/or sheds for the pet can be adduced.

A method of spraying the mineral functional water according to the present invention in a state of mist in a space of a house used by human and/or animals and/or in another space of a barn for keeping livestock is also preferably can be adduced as the method of indirectly making the mineral functional water according to the present invention act onto the same.

Since this method can prevent aerial infection, it is effective for preventing incidence and/or controlling propagation of the target to be controlled of unicellular organisms and/or viruses.

In this way, upon using the controlling method according to the present invention, infectious illness of human and/or animals derived from unicellular organisms and/or viruses can be prevented, and the improvement of the infectiosity illness can be also expected.

(2-2) Composition for Controlling Unicellular Organisms and/or Viruses

Composition for controlling unicellular organisms and/or viruses according to the present invention (hereinafter, called as “control composition according to the present invention”) contains the mineral functional water according to the present invention. The control composition according to the present invention can be used as either of a quasi-drug or a medicament, an effective amount thereof can be blended with a carrier pharmacologically permitted, and can be orally or parenterally medicated as a solid preparation and/or a liquid preparation.

A dosage form thereof is optional as long as capable of being normally used to be orally or parenterally medicated.

More concretely, as the dosage form used for oral administration or parenteral administration, a powder agent, a granular agent, a tablet, a capsule agent, a troche, or the like can be adduced as the solid preparation.

An internal liquid agent, an external liquid agent, suspension, emulsion, a syrup agent, injection solution, transfusion, or the like can be adduced as the liquid preparation, and dosage forms thereof or the like are suitably selected based on the object thereof.

These tablets or the like can be prepared according to the common practice thereof.

The control composition according to the present invention may be contained in an enough ratio for showing controlling effects upon the target of unicellular organisms and/or viruses, is not limited specially, and can optionally take formation and/or a kind of the same.

In this context, the control composition can be used as not only the quasi-drug and/or the medicament but also functional food and/or animal feed, or the like.

[3. Method of Producing Mineral Function Water According to the Present Invention]

A method of producing the mineral functional water containing mineral components radiating electromagnetic waves (hereinafter, may be called as “the mineral functional water according to the present invention”) is not specially limited, which can be, utilizing the producing apparatus disclosed in Reference 2 (Japanese patent application Laid-open No. 2011-56366), produced according to a method based on the methods disclosed therein.

As long as capable of obtaining the mineral functional water containing mineral components radiating electromagnetic waves, a method of producing the same is not limited to the above method utilizing the producing apparatus, and another method may be used instead thereof.

Hereinafter, referring to the attached drawings, preferable Embodiment related to a method of producing mineral function water according to the present invention utilizing the apparatus disclosed in Reference 2 (Japanese patent application Laid-open No. 2011-56366) will now be explained.

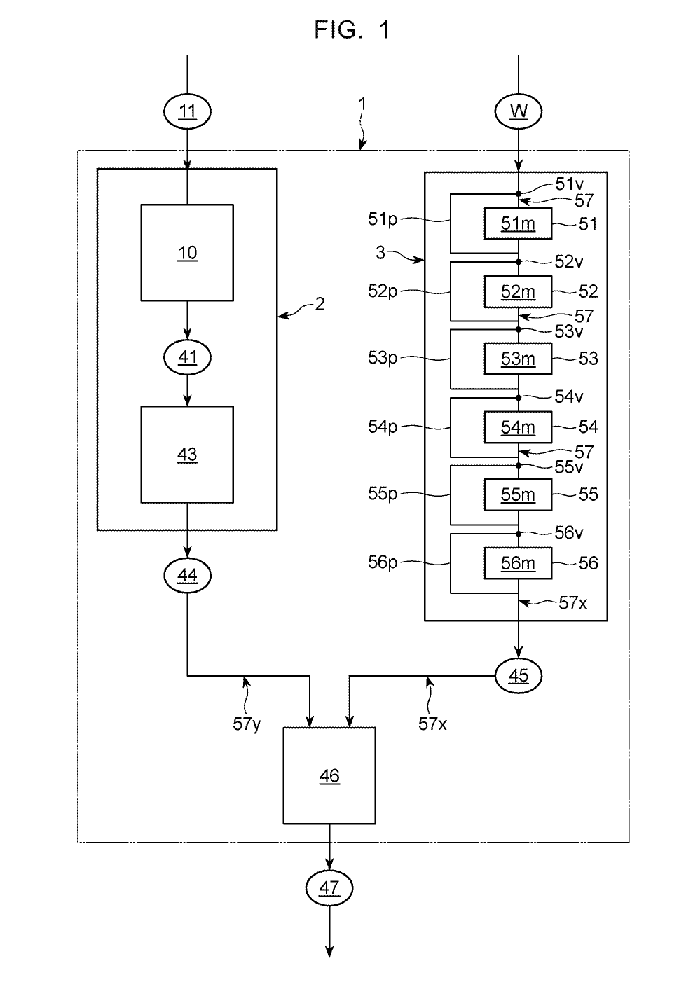

As shown in FIG. 1, mineral functional water-producing equipment 1 includes: the mineral-containing water (A) producing apparatus 2; the mineral-containing water (B) producing apparatus 3; and the mixing tank 46 which is a mixing unit for mixing mineral-containing water (A) 44 produced by the mineral-containing water (A) producing apparatus 2 with mineral-containing water (B) 45 produced by the mineral-containing water (B) producing apparatus 3 to form mineral functional water 47.

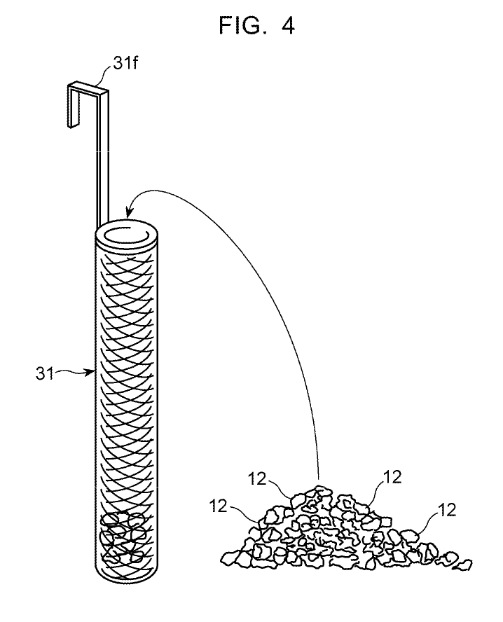

The mineral-containing water (A) producing apparatus 2 includes: the raw mineral water solution production unit 10 using raw material of water 11 supplied from waterworks and mineral-imparting material (A) 12 mentioned later (See, FIG. 4.) to form raw mineral water solution (A) 41; and an far-infrared ray-generating unit 43 irradiating far-infrared rays to the raw mineral water solution (A) 41 obtained by the raw mineral water solution production unit 10 to change the raw mineral water solution (A) 41 into mineral-containing water (A) 44.

The mineral-containing water (B) producing apparatus 3 has a function of forming the mineral-containing water (B) 45 containing mineral components eluted from mineral-imparting material by making water W supplied from the outside pass through the water-passing containers 51-56.

Hereinafter, details of the mineral-containing water (A) producing apparatus 2 and the mineral-containing water (B) producing apparatus 3 will now be explained.

(3-1: Mineral-Containing Water (A) Producing Apparatus)

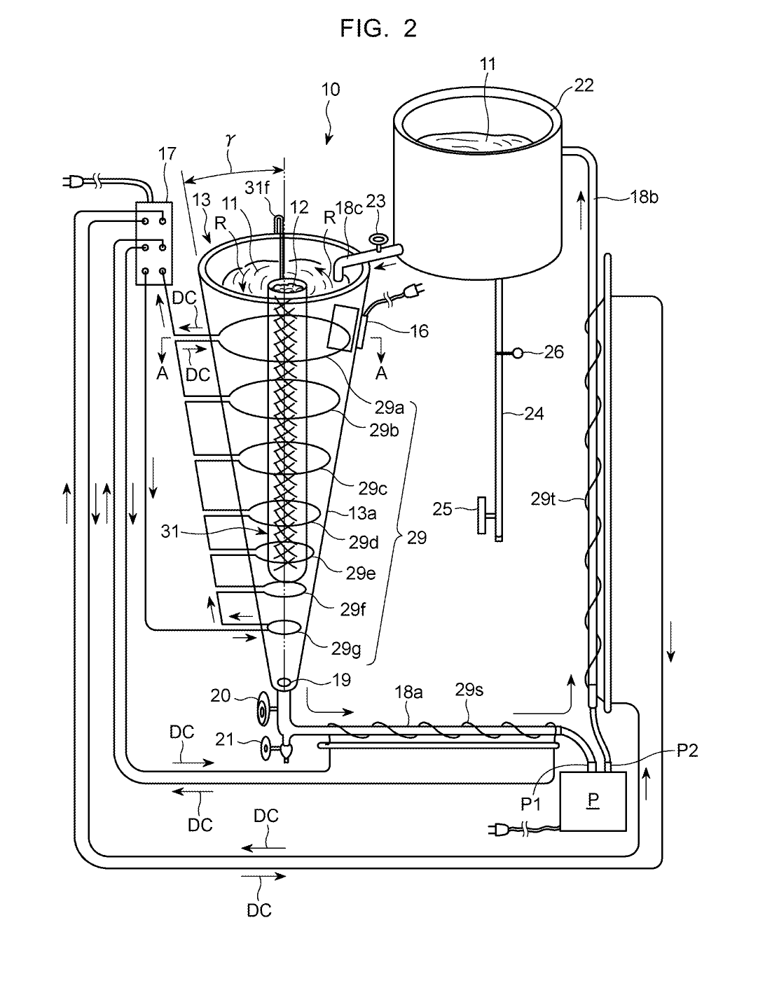

Next, referring to FIG. 2-FIG. 6, the mineral-containing water (A) producing apparatus 2 constituting the mineral functional water-producing equipment 1 shown in FIG. 1 is explained.

As shown in FIG. 1, the mineral-containing water (A) producing apparatus 2 includes: the raw mineral water solution production unit 10 (See, FIG. 2) using raw material of water 11 supplied from waterworks and mineral-imparting material (A) 12 mentioned later (See, FIG. 4) to form raw mineral water solution (A) 41; and the far-infrared ray-generating unit 43 (See, FIG. 6) irradiating far-infrared rays to the mineral-containing water (A) solution 41 obtained by the raw mineral water solution production unit 10 to change the mineral-containing water (A) solution 41 into the mineral-containing water (A) 44.

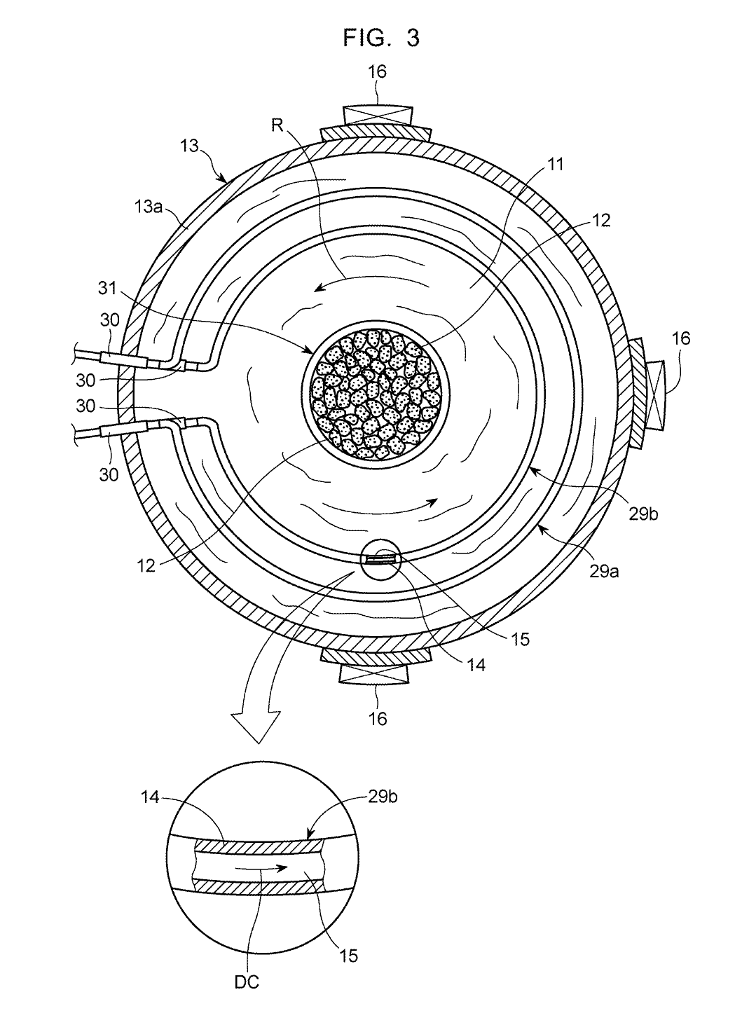

As shown in FIG. 2 and FIG. 3, the raw mineral water solution production unit 10 includes: a reaction vessel 13 capable of storing the water 11 and the mineral-imparting material (A) 12 therein; the conductive wire 15 covered with the insulator 14 and immersed into the water 11 of the reaction vessel 13; the ultrasonic wave generation unit 16 applying ultrasonic vibration onto the water 11 in the reaction vessel 13; the DC power supply device 17 conducting DC electric current to the conductive wire 15; the circulating passages 18a and 18b which are means for generating the water flow R around the conductive wire 15 in the same direction as that of the DC electric current; and the circulation pump P.

Each of the DC power supply device 17, the ultrasonic wave generation unit 16, and the circulation pump P operates using electric supply from general commercial power.

The reaction vessel 13 is formed in a shape of an inverted conical whose upper surface is opened, and the drain port 19 is provided with a bottom thereof corresponding to the lower summit of the conical.

The circulating passage 18a communicating with the suction port P1 of the circulation pump P is connected to this drain port 19. The opening control valve 20 for adjusting volume of wastewater to the circulating passage 18a and the drain valve 21 for discharging the water or the like in the reaction vessel 13, are provided directly under the drain port 19.

A proximal end of the circulating passage 18b is connected to the discharge port P2 of circulation pump P, and a distal end of the circulating passage 18b is connected to the housing tank 22.

A proximal end of the circulating passage 18c for transporting the water 11 in the housing tank 22 into the reaction vessel 13 is connected near a bottom portion on the outer periphery of the housing tank 22, and a distal end of the circulating passage 18c is piped at a position facing an opening portion of the reaction vessel 13.

The opening control valve 23 for adjusting an amount of water transported into the reaction vessel 13 from the housing tank 22 is provided with the circulating passage 18c.

The drain pipe 24 including: the drain valve 25; and the water temperature gage 26, is connected to a bottom portion of the housing tank 22 in a suspended state.

If needed, upon opening the drain valve 25, the water in housing tank 22 can be discharged from a bottom end of the drain pipe 24, and at this time temperature of the water 11 passing through the drain pipe 24 can be measured with the water temperature gage 26.

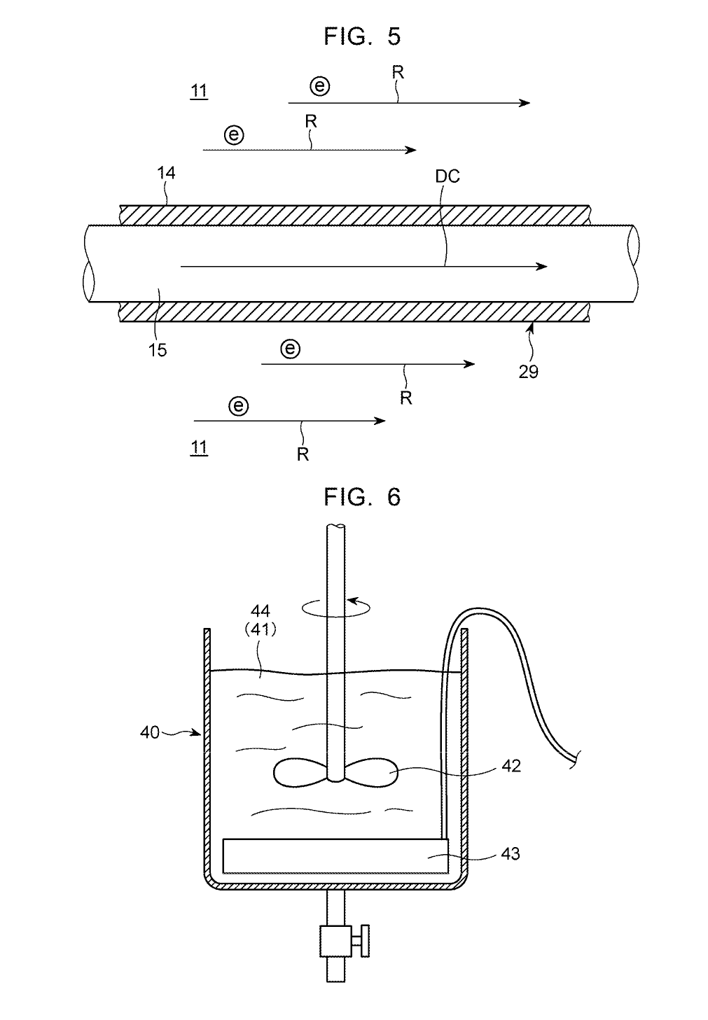

As shown in FIG. 5, the plurality of conductive cables 29 (29a-29g) each of which includes: the conductive wire 15; and the insulator 14 covering the wire are wired so as to have shapes of rings located at positions having different depth from each other in the reaction vessel 13, respectively. All of the plurality of conductive cables 29a-29g and the reaction vessel 13 are coaxially arranged.

According to inside diameters of the reaction vessel 13 in the shape of the inverted conical, inside diameters of the plurality of conductive cables 29a-29g are gradually contracted so as to be a diameter corresponding to the respective arranged position thereof.

Each of the plurality of conductive cables 29a-29g is detachably connected to the insulating terminal 30 provided with the wall body 13a of the reaction vessel 13, if needed, a circular portion of the cables may be detached from the terminal 30, or may be attached thereto.

The cylindrical housing container 31 having a bottom portion and being formed with an insulating reticulum, is arranged at a portion corresponding an axial center of the reaction vessel 13. And, the mineral-imparting material (A) 12 is filled up within the housing container 31.

This housing container 31 is, by the hook 31f provided with an upper portion thereof, detachably engaged with an upper edge portion of the wall body 13a of the reaction vessel 13.

As shown in FIG. 2, the conductive cables 29s and 29t are spirally twisted around the periphery of the circulating passages 18a and 18b, respectively. DC electric current is supplied from the DC power supply device 17 to these conductive cables 29s and 29t.

A direction in which the DC electric current flows through the conductive cables 29s and 29t is set up so as to meet a direction in which the water flow runs within the circulating passages 18a and 18b.

In the raw mineral water solution production unit 10, a predetermined amount of water 11 is put into the reaction vessel 13 and the housing tank 22.

After having set the housing container 31, into which the mineral-imparting material (A) 12 has been filled up, to a center of the reaction vessel 13, the circulation pump P is activated, and the opening control valve 20 provided with the bottom portion of the reaction vessel 13 and the opening control valve 23 of the circulating passage 18c are adjusted.

Next, the water 11 from the reaction vessel 13 is made circulate so as to pass through the drain port 19, the circulating passage 18a, the circulation pump P, the circulating passage 18b, the housing tank 22, and the circulating passage 18c, thereby returning to the upper portion of the reaction vessel 13 again.

And then, upon activating the DC power supply device 17 and the ultrasonic wave generation unit 16, the elution reaction of the mineral components from the mineral-imparting material (A) 12 in the housing container 31 to the water 11 begins.

The working conditions when producing the raw mineral water solution (A) using the raw mineral water solution production unit 10 are not limited in particular. In this Embodiment, however, the raw mineral water solution (A) has been produced according to the following working conditions.

(1) The DC electric current DC having voltage of 8000-8600 V and current of 0.05-0.1 A has been conducted through the conductive cables 29, 29s, and 29t.

The insulator 14 constituting the conductive cable 29 or the like is made of polytetrafluoroethylene resin.

(2) The mineral-imparting material (A) 12 is filled up in the reaction vessel 13 with a mass ratio of 10 to 15% based on the water 11.

The mineral-imparting material (A) 12 will be explained later referring to concrete examples.

(3) It is sufficient that the water 11 merely contain electrolyte so that the DC electric current can work there-through.

For example, when containing about 10 g of sodium carbonates, which is a kind of electrolyte, based on 100 liters of the water, the water may be used as the water 11.

Alternatively, groundwater, as it is, can be used as the water 11.

(4) The ultrasonic wave generation unit 16 generates ultrasonic waves having a frequency of 30-100 kHz, and is arranged so that an ultrasonic vibration portion (not shown) thereof directly contact with the water 11 in the reaction vessel 13 to make the water 11 vibrate.

When the raw mineral water solution production unit 10 is activated on such conditions, in the reaction vessel 13, the water flow R rotating in a direction of a left-hand thread and being sucked into the drain port 19 occurs, the water 11 discharged from the drain port 19 passes through the circulating passages 18a and 18b or the like, and returns again into the reaction vessel 13. This state is continued.

Therefore, agitating action by the water flow R, action of the direct electric current flowing through the conductive cable 29, and ultrasonic vibration generated by the ultrasonic wave generation unit 16, make mineral components speedily elute from the raw mineral water solution (A) into the water 11, thereby enabling to produce with high efficiency the mineral-imparting material (A) 12 that necessary mineral components have been moderately dissolved therein.

In the raw mineral water solution production unit 10, the plurality of conductive cables 29a-29g, each of which is formed in the shape of the ring, are coaxially arranged within the reaction vessel 13. The water flow R rotating in the direction of the left-hand thread within the reaction vessel 13 is also generated.

Due to this, a comparatively dense field of electrical energy can be formed within the reaction vessel 13 of fixed volume. In other words, the raw mineral water solution (A) can be efficiently produced within the reaction vessel 13 having comparatively small capacity.

The reaction vessel 13 is formed in the shape of the inverted conical. Therefore, the water flow R flowing along with the plurality of conductive cables 29a-29g in the shapes of the rings can be generated comparatively easily and stably, thereby promoting elution of the mineral components.

The water flow R flowing in the inside of reaction vessel 13 shaped of the inverted conical increases flow velocity thereof as it goes toward the drain port 19 at the bottom portion of the reaction vessel 13. Therefore, contact frequency with the mineral-imparting material (A) 12 can also increase so as to catch more free electrons e existing in the water 11, thereby capable of increasing an amount of ionized minerals.

Furthermore, the housing tank 22 discharging and storing water 11 is provided between the circulating passages 18b and 18c. Therefore, while circulating the water 11 whose amount is greater than the volume of the reaction vessel 13, elution action of minerals can proceed.

For this reason, the raw mineral water solution (A) can be mass-produced with remarkably high efficiency.

When the circulation pump P is made continuously run to continue the above action, the raw mineral water solution (A) in which the mineral components have been eluted is produced as a result.

According to conditions including: the size of the drain port 19 at the bottom portion of the reaction vessel 13; the amount of circulating water; the shape (especially, the angle γ shown in FIG. 2 between the axial center C and the wall body 13a) of the reaction vessel 13; and so on, the appearance situation of free electrons e in the water 11 can be controlled. Action of the free electrons e upon the mineral-imparting material (A) 12 may change the water solubility of the mineral components.

When the raw mineral water solution (A) has been formed, this raw mineral water solution (A) 41 is moved into the treatment container 40 shown in FIG. 6.

At this stage, the residue of the mineral-imparting material (A) 12 leaked from the housing container 31 in the reaction vessel 13 can be discharged from the drain valve 21 at the bottom portion of the reaction vessel 13.

The far-infrared ray-generating unit 43 arranged within the treatment container 40 irradiates far-infrared rays to the raw mineral water solution (A) 41 stored in the treatment container 40 while the raw mineral water solution (A) is slowly agitated by the agitation blades 42.

It is sufficient for the far-infrared ray-generating unit 43 to generate far-infrared rays with wavelengths of about 6-14 micrometers. The material and/or the generating unit thereof may be optional, and a heating method may be used for the same.

However, it is preferable that the unit has, at 25 Centigrade, emissivity of 85% or more to the radiation of the black body within a band of 6-14 micrometer wavelengths.

In the raw mineral water solution production unit 10 shown in FIG. 2, according to: the agitation action by the water flow R; the action by the DC electric current conducting through the conductive wire 15; and the ultrasonic vibration, the mineral components contained in the mineral-imparting material (A) 12 speedily elutes into the water 11, thereby enabling to produce the mineral water solution 41 in which necessary mineral components have been moderately melt with high efficiency.

The far-infrared ray-generating unit 43 shown in FIG. 6 irradiates far-infrared rays to the mineral water solution 41 to amalgamate dissolved mineral components with water molecules, thereby producing the mineral-containing water (A) 44 whose electro-negativity is increased.

As shown in FIG. 1, the mineral-containing water (A) 44 formed according to the above-mentioned processes in the mineral-containing water (A) producing apparatus 2 is transported into the mixing tank 46 via the water supply passage 57y, and is mixed with the mineral-containing water (B) 45 transported from the mineral-containing water (B) producing apparatus 3 within the mixing tank 46.

Hereinafter, the mineral-imparting material (A) will now be explained. The mineral-imparting material (A) contains: the vegetation raw material including at least one kind selected from a group consisting of vegetation belonging to Asteraceae, and vegetation belonging to Rosaceae; and the woody plant raw material of woody plants including at least one kind selected form a group consisting of Maple, Betula platyphylla, Pinus, and Oyptomeria japonica.

Used parts thereof may be suitably selected from portions from which mineral components are easily eluted such as leaf parts, stem parts, flower parts, and bark parts thereof, and the selected one may be used as it is. Alternatively, the selected one may be dried to be used.

Vegetation other than Asteraceae and Rosaceae may be included. However, it is preferable that the only vegetation belonging to Asteraceae and Rosaceae is used.

For example, when vegetation belonging to Brassicaceae and/or Pinaceae is added, the controlling effects upon the unicellular organisms, which are one of beneficial effects of the mineral functional water according to the present invention, will greatly fall. The reason why, however, is unknown unfortunately.

As the mineral-imparting material (A), the following mineral-imparting material (A′) can be adduced.

Dried pulverized product of Asteraceae plants and dried pulverized product of Rosaceae plants are used as the mineral-imparting material (A′); the dried pulverized product of the Asteraceae plants is produced by: mixing 8 to 12 weight % of Cirsium japonicum (leaf parts, stem parts and flower parts thereof), 55 to 65 weight % of Artemisia indica (leaf parts and stem parts thereof) and 27 to 33 weight % of Farfugium japonicum (leaf parts and stem parts thereof), respectively to produce first mixture thereof; making the first mixture dry; and then pulverizing the dried first mixture; the dried pulverized product of the Rosaceae plants is produced by: mixing 17 to 23 weight % of Rosa multiflora (leaf parts and flower parts thereof), 8 to 12 weight % of Geum japonicum (leaf parts and stem parts thereof), and 65 to 75 weight % of Ruhus L. (leaf parts, stem parts, and flower parts thereof), respectively to produce second mixture thereof; making the second mixture dry; and then pulverizing the dried second mixture; the dried pulverized product of the Asteraceae plants and the dried pulverized product of the Rosaceae plants are mixed according to 1:0.8 to 1:1.2 (weight ratio) to obtain vegetation raw material (A1); the woody plant raw material (A2) is produced by: mixing 22 to 28 weight % of Maple (leaf parts and stem parts thereof), 22 to 28 weight % of Betula platyphylla (leaf parts, stem parts, and bark parts thereof), and 45 to 55 weight % of Cryptomeria japonica (leaf parts, stem parts, and bark parts thereof) to produce third mixture; making the third mixture dry; and then pulverizing the dried third mixture; and mineral-imparting material (A′) is obtained by mixing the vegetation raw material (A1) and the woody plant raw material (A2) according to 1:2.7 to 1:3.3 (weight ratio).

Also in the mineral-imparting material (A′), more preferably, dried pulverized product of Asteraceae plants and dried pulverized product of Rosaceae plants are used as the mineral-imparting material (A′); the dried pulverized product of the Asteraceae plants is produced by: mixing 10 weight % of Cirsium japonicum (leaf parts, stein parts and flower parts thereof), 60 weight % of Artemisia indica (leaf parts and stem parts thereof) and 30 weight % of Farguium japonicum (leaf parts and stein parts thereof), respectively to produce first mixture thereof; making the first mixture dry; and then pulverizing the dried first mixture; the dried pulverized product of the Rosaceae plants is produced by: mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture; the dried pulverized product of the Asteraceae plants and the dried pulverized product of the Rosaceae plants are mixed according to 1:1 (weight ratio) to obtain vegetation raw material (A1); the woody plant raw material (A2) is produced by: mixing 25 weight % of Maple (leaf parts and stem parts thereof), 25 weight % of Betula platyphylla (leaf parts, stem parts, and bark parts thereof), and 50 weight % of Cryptomeria japonica to produce third mixture; making the third mixture thy; and then pulverizing the dried third mixture; and mineral-imparting material (A′) is obtained by mixing the vegetation raw material (A1) and the woody plant raw material (A2) according to 1:3 (weight ratio).

As the vegetation raw material (A1), “P-100 (lot number)” produced by Riken techno system Co., LTD. can be preferably used. And, as the woody plant raw material (A2), “P-200 (lot number)” produced by Riken techno system Co., LTD. can be preferably used.

(3-2: Mineral-Containing Water (B) Producing Apparatus)

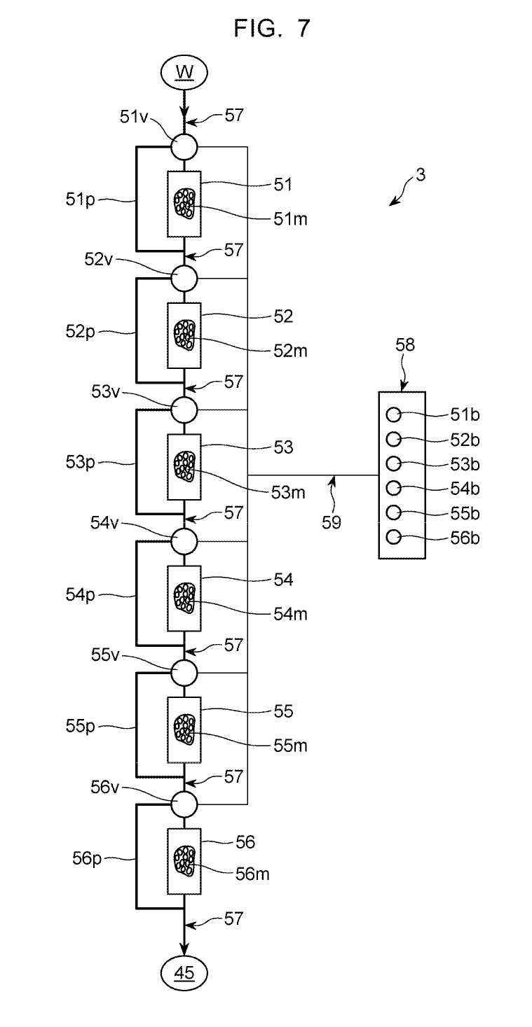

Next, referring to FIG. 1 and FIG. 7, the structure and the functions of the mineral-containing water (B) producing apparatus 3, or the like will now be explained. As shown in FIG. 1 and FIG. 7, the mineral-containing water (B) producing apparatus 3 includes: the first, the second, the third, the fourth, the fifth, and the sixth water-passing containers 51-56 into which a different kind of mineral-imparting material (B) from each other is filled up, respectively; the water supply passage 57 communicating the plurality of water-passing containers 51-56 in series; and the roundabout channels 51p-56p connected to the water supply passage in a state where the roundabout channel is parallel to the plurality of water-passing containers 51-57, respectively; and the water stream-changing valves 51v-56v provided in branch parts from the water supply passage 57 and the roundabout channels 51p-56p, respectively.

The operation of switching the water stream-changing valves 51v-56v can be performed by operating the six switching buttons 51b-56b provided on the operation panel 58 connected to these water stream-changing valves 51v-56v via the signal cables 59.

The six switching buttons 51b-56b and the six water stream-changing valves 51v-56v correspond to each other according to the numbers thereof. Upon operating a certain one of the switching buttons 51b-56b, one of the water stream-changing valves 51v-56v having a number corresponding to the certain one is switched to change the direction of a water flow related thereto.

Here, the mineral-imparting material (B) 51m-56m can be preferably produced by mixing raw material based on a lime stone, fossil coral, and shell.

Firstly, components contained in the lime stone, the fossil coral, and the shell are analyzed, and the amounts of silicon dioxide, iron oxide, activated carbon, titanium nitride, calcium carbonate, magnesium carbonate, and calcium phosphate are evaluated, respectively.

Secondly, based on the respective content of the components, the lime stone, the fossil coral, and the shell are mixed to produce the mineral-imparting material (B) 51m-56m.

It is preferable that components contained in the mineral-imparting material (B) 51m-56m is controlled according to the mixing ratio of the lime stone, the fossil coral, and the shell. However, in some cases, the material of the lime stone, the fossil coral, and the shell has poor component(s) according to the source thereof. If so, at least one of silicon dioxide, iron oxide, activated carbon, titanium nitride, calcium carbonate, magnesium carbonate, and calcium phosphate may be added, if needed.

Especially, since the activated carbon is rarely contained in the lime stone, the fossil coral, and the shell, the activated carbon should usually be added separately.

When as the mineral-imparting material (B) 51m-56m, the mineral-imparting material (B1) filled into the first water-passing container 51 is mixture including: 70 weight % of lime stone; 15 weight % of fossil coral; and 15 weight % of shell, respectively; the mineral-imparting material (B2) filled into the second water-passing container 52 is mixture including: 40 weight % of lime stone; 15 weight % of fossil coral; 40 weight % of shell; and 5 weight % of activated carbon, respectively; the mineral-imparting material (B3) filled into the third water-passing container 53 is mixture including: 80 weight % of lime stone; 15 weight % of fossil coral; and 5 weight % of shell, respectively; the mineral-imparting material (B4) filled into the fourth water-passing container 54 is mixture including: 90 weight % of lime stone; 5 weight % of fossil coral; and 5 weight % of shell, respectively; the mineral-imparting material (B5) filled into the fifth water-passing container 55 is mixture including: 80 weight % of lime stone; 10 weight % of fossil coral; and 10 weight % of shell, respectively; and the mineral-imparting material (B6) filled into the sixth water-passing container 56 is mixture including: 60 weight % of lime stone; 30 weight % of fossil coral; and 10 weight % of shell, respectively, the mineral-containing water (B) that shows excellent controlling effects can be obtained upon being mixed with the mineral-containing water (A).

Especially, it is preferable that the lime stones, the fossil coral, and the shell that are used for the mineral-imparting material (B1)-(B6) satisfy the following Items (1-1) to (1-3).

Item (1-1): Lime Stone

The lime stone is a small stone produced by crushing a rock of lime in which volcanic ore deposits containing the following components are mixed into a size of about 3 cm:

calcium carbonate: 50 weight % or more;

iron oxide: 3 to 9 weight % of iron; and

sum total of titanium oxide, titanium carbide, titanium nitride: 0.8 weight % or more, and

magnesium carbonate: 7 to 10 weight %.

“CC-200 (lot number)” produced by Riken techno system Co., LTD. can be preferably used as such a lime stone.

(1-2) Fossil Coral:

The fossil coral is granular material produced by mixing the following the two kinds of raw fossil coral according to a weight ratio of 1:9 to form mixture, and crushing the mixture into the size within 3-5 mm, the two kinds of raw fossil coral including: first fossil coral produced about 100 meters below the ground whose crystal construction has been denatured by pressure; and

second fossil coral produced from land near Amamiohshima Island, Okinawa-Ken, Japan, and including: calcium carbonate; calcium phosphate; and other trace elements. As such fossil coral, “CC-300 (lot number)” produced by Riken techno system Co., LTD. can be preferably used.

(1-3) Shell:

The shell is granular material produced by mixing ear shell, abalone, and acorn shell of the same weight to form mixture, and crushing the mixture into the size within 3-5 mm.

“CC-400 (lot number)” produced by Riken techno system Co., LTD. can be preferably used as such shell.

(1-4) Activated Carbon

The activated carbon may be made of optional material. However, preferably, activated carbon made of coconut shell can be adduced.

For example, “CC-500 (lot number)” produced by Riken techno system Co., LTD. whose raw material is coconut shell made in Thailand can be adduced.

Upon operating the switching buttons 51b-56b on the operation panel 58 mentioned above to switch the water stream-changing valves 51v-56v to the water-passing container side, water having passed through water supply passage 57 flows in into the first water-passing container 51 through the sixth water-passing container 56 located at the downstream of the operated water stream-changing valves. Alternatively, upon switching the water stream-changing valves 51v-56v to the roundabout channel side, the water having passed through water supply passage 57 flows into the roundabout channels 51p-56p located at the downstream of the operated water stream-changing valves.

Therefore, operating any of the switching buttons 51b-56b to selectively change the water stream-changing valves 51v-56v enables to produce the mineral-containing water (B) 45 into which mineral components selectively eluted from the mineral-imparting material (B) 51m-56m whose mineral components differ from each other according to the first water-passing container 51 through the sixth water-passing container 56.

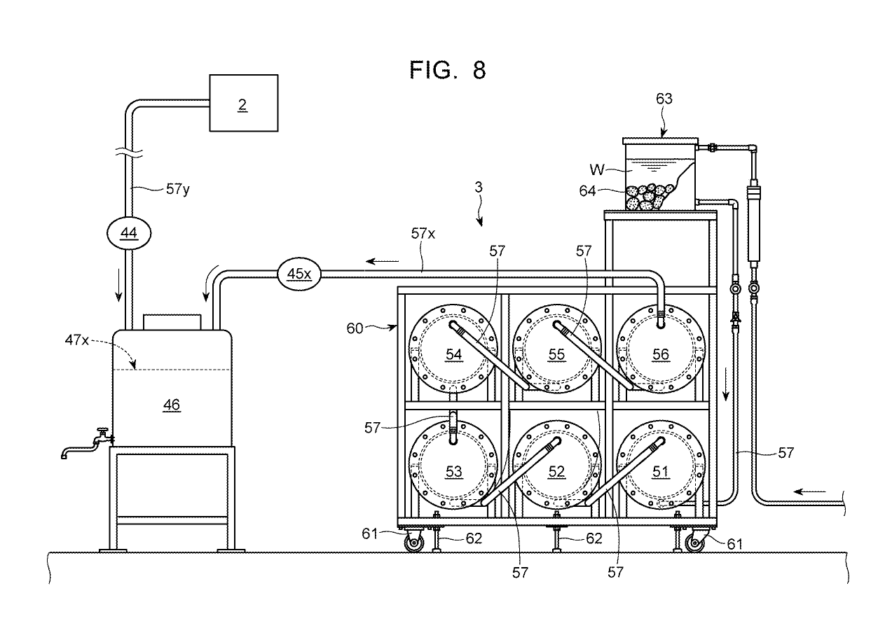

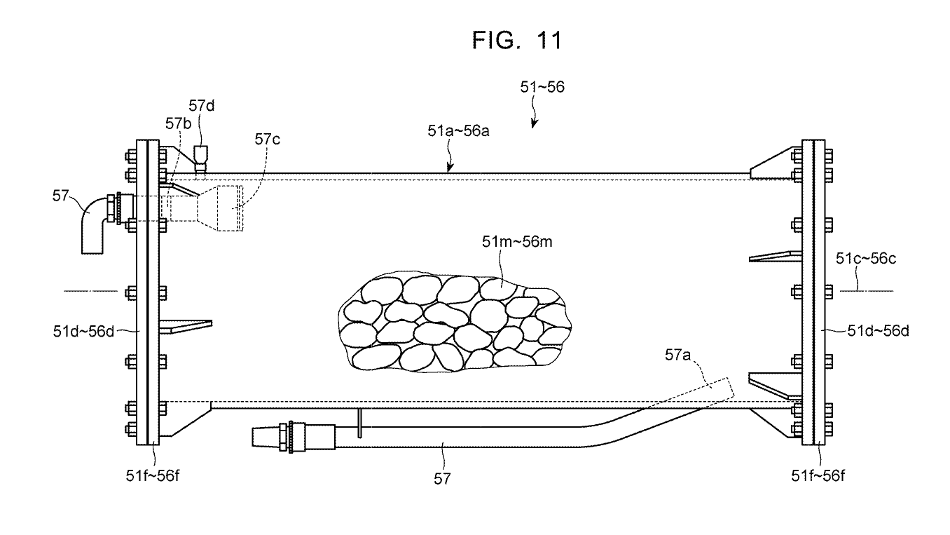

Next, referring to FIG. 8 through FIG. 11, the practical structure and functions of the mineral-containing water (B) producing apparatus 3 will now be explained.

In FIG. 8 through FIG. 10, the roundabout channels 51p-56p, the water stream-changing valves 51v-56v, the operation panel 58, and the signal cables 59, which have been mentioned above, are omitted therefrom.

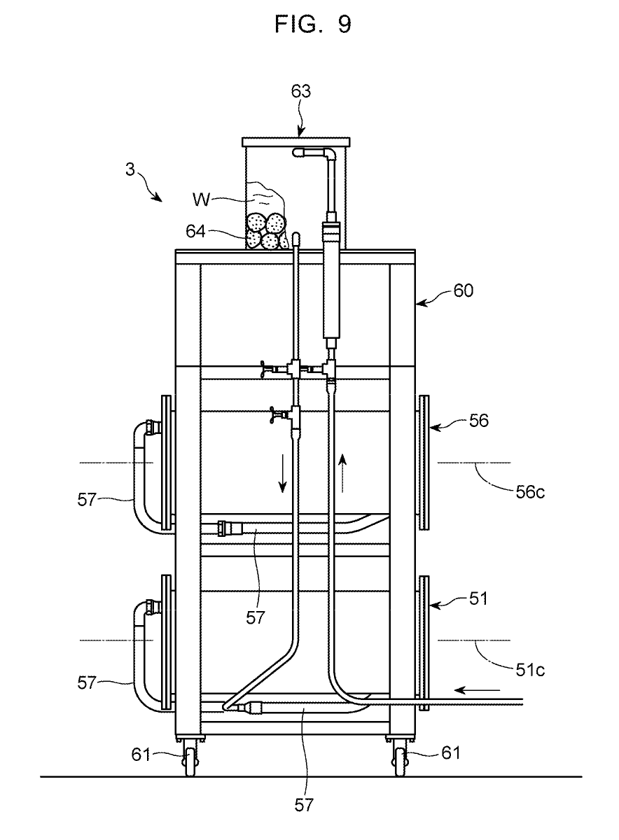

As shown in FIG. 8 and FIG. 9, the mineral-containing water (B) producing apparatus 3 includes: the first water-passing container 51 through the sixth water-passing container 56 each of which has a cylindrical shape and have been mounted on the support frame 60; and the water supply passage 57 communicating in series the first water-passing container 51 through the sixth water-passing container 56, wherein the raw water tank 63 for storing water W supplied from waterworks is arranged at the top part of the support frame 60.

In the raw water tank 63, the inorganic porous body 64 having a function of adsorbing impurities in the water W therein is stored.

The castors 61 and the level adjusters 62 are provided with the bottom portion of the support frame 60.

The first water-passing container 51 through the sixth water-passing container 56, each of which is cylindrically shaped, are mounted on the support frame 60 having a rectangular parallelepiped lattice structure in a state where each of axial centers 51c-56c (See, FIG. 9) of the containers are kept horizontally.

The first water-passing container 51 through the sixth water-passing container 56 has been detachably attached onto the support frame 60.

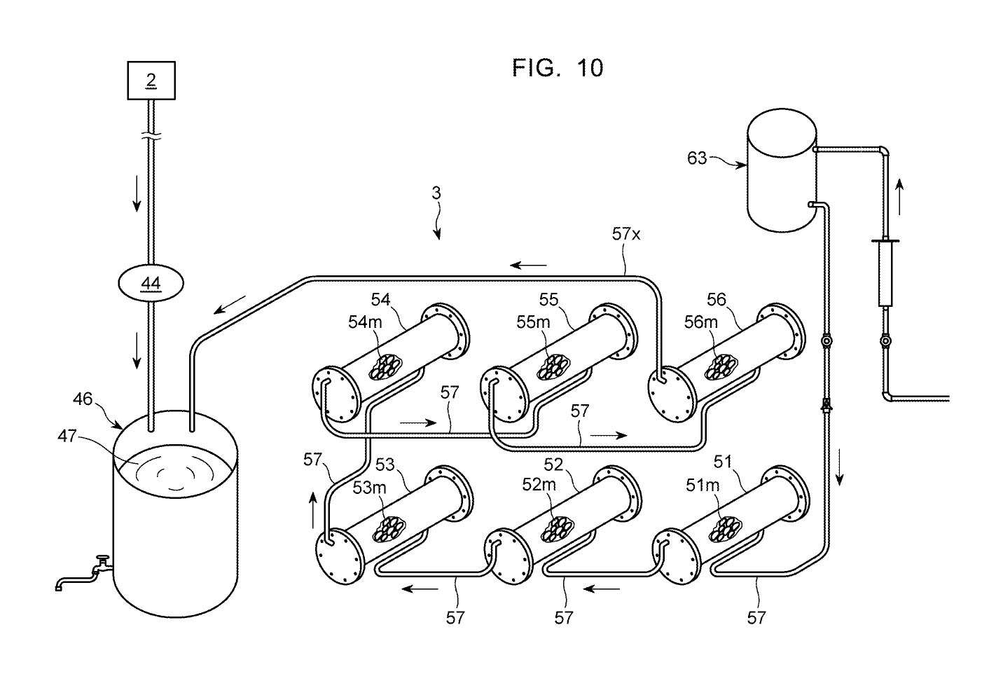

As shown in FIG. 10, the first water-passing container 51 through the sixth water-passing container 56 has the same structure, respectively. Each airtight structure thereof is formed by attaching the disk shaped lid bodies 51d-56d to the flange parts 51f-56f provided with the both ends of the main body parts 51a-56a in cylindrical shapes.

At the lowest portion of the main body parts 51a-56a when the axial centers 51c-56c are in horizontal states, the water inlet 57a communicating with the water supply passage 57 is provided. At the highest portion (far from the water inlet 57a) of the lid bodies 51d-56d, the water outlet 57b communicating with the water supply passage 57 is provided. And, the mesh strainer 57c is attached to the water outlet 57b.

The automatic air valves 57d for releasing air in the first water-passing container 51 through the sixth water-passing container 56 are attached onto the outer peripheries (the directly above portions of the water outlet 57b) of the main body parts 51a-56a.

The water supplied from the water supply passage 57 in the upstream passes through the water inlet 57a, flows into the first water-passing container 51 through the sixth water-passing container 56, and contacts with the mineral-imparting material (B) 51m-56m with which have been filled up therein, respectively. Therefore, the respective mineral components elute into the water to form water containing mineral components corresponding to the mineral-imparting material (B) 51m-56m, and the formed water flows from the water outlet 57b into the water supply passage 57 in the downstream.

In the mineral-containing water (B) producing apparatus 3 shown in FIG. 8-FIG. 10, operating any of the switching buttons 51b-56b on the operation panel 58 shown in FIG. 7 to make the water W in the raw water tank 63 pass through at least one of the first water-passing container 51 through the sixth water-passing container 56 enables to produce the mineral-containing water (B) 45 into which the special respective mineral components contained in the mineral-imparting material (B) 51m-56m filled up within the first water-passing container 51 through the sixth water-passing container 56 have been selectively dissolved therein.

Since the first water-passing container 51 through the sixth water-passing container 56 are connected in series with the water supply passage 57 in the mineral-containing water (B) producing apparatus 3, continuously making water flow into the water supply passage 57 enables to mass-produce the mineral-containing water (B) 45 that the mineral components corresponding to the mineral-imparting material (B) 51m-56m in the first water-passing container 51 through the sixth water-passing container 56 have been dissolved therein.

The mineral-containing water (B) 45 produced by the mineral-containing water (B) producing apparatus 3 is transported from the sixth water-passing container 56 via the water supply passage 57x in the downstream thereof into the mixing tank 46, and is therein mixed to the mineral-containing water (A) 44 produced by the mineral-containing water (A) producing apparatus 2 shown in FIG. 1, thereby forming the mineral functional water 47.

The mixing ratio of the mineral-containing water (A) and the mineral-containing water (B) is suitably determined considering: the kind of material included in the mineral-containing water (A) and the mineral-containing water (B); and the density of eluted components.

The weight ratio (the mineral-containing water (A): the mineral-containing water (B)) of the mineral-containing water (A) and the mineral-containing water (B) is: within a range of 1:5-1:20; preferably within a range of 1:7-1:12; and more preferably within a range of 1:10.

Both in a first case where the mineral-containing waters (A) is too little (the mineral-containing waters (B) is too much) and in a second case where the mineral-containing waters (A) is too much (the mineral-containing waters (B) is to little), there is a possibility that effective components contained in the mineral ftinctional water are so much diluted that objective action is insufficiently showed.

In the above, the preferable Embodiment of the method of producing the mineral function water according to the present invention has been described. It is, however, sufficient that the mineral functional water according to the present invention including the above-mentioned configuration. Methods other than the above may be adopted instead thereof. In other words, it should be understood that the above description is not restrictive.

Especially, items that are not explicitly disclosed in the Embodiment, for example, operating conditions, running conditions, various parameters including a size of the elements, weight, volume, or the like do not deviate from a range where a person skilled in the art usually uses. Values capable of being easily assumed by the ordinary person skilled in the art are adopted.

### EXAMPLES

Hereinafter, the present invention will now be more concretely explained adducing the following Examples. Needless to say, the present invention is NEVER limited to the Examples.

### Example 1

[1. Manufacturing Mineral Functional Water]

The mineral functional water producing apparatus in the Embodiment and the producing method mentioned above have been used. And then, as the mineral functional water, the mineral functional water in Example 1 has been produced utilizing the following material and the following method.

1. Manufacturing Mineral-Containing Water (A)

Raw material for producing the mineral-imparting material (A) for the mineral-containing water (A) includes the vegetation raw material (A1) and the woody plant raw material (A2) shown below.

As the vegetation raw material (A1), “P-100 (lot number)” produced by Riken techno system Co., LTD. have been used. As the woody plant raw material (A2), “P-200 (lot number)” produced by Riken techno system Co., LTD. has been used.

“P-100” is the vegetation raw material (A1) produced by mixing the following dried pulverized product of Asteraceae plants and the following dried pulverized product of Rosaceae plants according to a weight ratio of 1:1, and “P-200” is the woody plant raw material (A2) described below.

(A1) Vegetation Raw Material (Dried Vegetation Plants)

(A1-1) Dried Pulverized Product of Asteraceae Plants

This has been produced by: mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof); respectively to produce first mixture thereof; making the first mixture dry; and then pulverizing the dried first mixture.

(A1-2) Dried Pulverized Product of Rosaceae Plants

This has been produced by: mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof); respectively to produce second mixture thereof; making the second mixture dry; and then pulverizing the dried second mixture.

(A2) Woody Plant Raw Material (Dried Woody Plants)

This has been produced by: mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof); respectively to produce third mixture thereof; making the third mixture dry; and then pulverizing the dried third mixture.

The raw mineral water solution (A) has been produced by:

mixing the vegetation raw material (A1) and the woody plant raw material (A2) according to a weight ratio of 1:3 to produce the mineral-imparting material (A); putting 10 to 15 weight % of the mineral-imparting material (A) based on the water into the raw mineral water solution production unit 10 (See, FIG. 2) of the mineral-containing water (A) producing apparatus 2 shown in FIG. 1;

conducting DC electric current having voltage of 8300 V and current of 100 mA has been conducted through the conductive wires of the raw mineral water solution production unit 10 to generate water flow around the conductive wires in the same direction as the DC electric current; and

applying ultrasonic vibration (oscillating frequency of 50 kHz, amplitude of 1.5/1000 mm) to the water, thereby producing the raw mineral water solution (A).

Next, far-infrared rays (wavelengths: 6-14 micrometers) have been irradiated to the mineral water solution 41 supplied to the latter far-infrared ray-generating unit 43 to obtain the mineral-containing water (A) in Example 1.

2. Manufacturing Mineral-Imparting Material (B)

The raw material for producing the mineral-imparting material (B) for the mineral-containing water (B), which has been produced by: mixing the lime stone, the fossil coral, the shell, and the activated carbon to produce fourth mixture thereof; and then pulverizing the fourth mixture, has been used.

Material of the mineral-imparting material (B) and the mixture (mineral-imparting material (B1)-(B6)) used for the first passing container through the sixth water-passing container will now be explained as follows.

(1) Material

(1-1) Lime Stone: “CC-200 (Lot Number)” Produced by Riken Techno System Co., LTD.

The lime stone is a small stone produced by crushing a rock of lime in which volcanic ore deposits containing the following components are mixed into a size of about 3 cm: calcium carbonate: 50 weight % or more; iron oxide: 3 to 9 weight % of iron; and sum total of titanium oxide, titanium carbide, titanium nitride: 0.8 weight % or more, and magnesium carbonate: 7 to 10 weight %.

(1-2) “CC-300 (Lot Number)” Produced by Riken Techno System Co., LTD.

The fossil coral is granular material produced by mixing the following the two kinds of raw fossil coral according to a weight ratio of 1:9 to form mixture, and crushing the mixture into the size within 3-5 mm, the two kinds of raw fossil coral including: first fossil coral produced about 100 meters below the ground whose crystal construction has been denatured by pressure; and second fossil coral produced from land near Amamiohshima Island, Okinawa-Ken, Japan, and including: calcium carbonate; calcium phosphate; and other trace elements.

(1-3) Shell: “CC-400 (Lot Number)” Produced by Riken Techno System Co., LTD.

The shell is granular material produced by mixing ear shell, abalone, and acorn shell of the same weight to form mixture, and crushing the mixture into the size within 3-5 mm.

(1-4) Activated Carbon (Only used for the Second Water-Passing container): “CC-500 (Lot Number)” Produced by Riken Techno System Co., LTD.

(2) Weight Ratios in the First through the Sixth Water-Passing Containers

The first water-passing container:

The mineral-imparting material (B1) is mixture including: 70 weight % of lime stone; 15 weight % of fossil coral; and 15 weight % of shell.

The second water-passing container:

The mineral-imparting material (B2) is mixture including: 40 weight % of lime stone; 15 weight % of fossil coral; 40 weight % of shell; and 5 weight % of activated carbon, which corresponds to silicon dioxide and activated carbon.

The third water-passing container:

The mineral-imparting material (B3) is mixture including: 80 weight % of lime stone; 15 weight % of fossil coral; and 5 weight % of shell.

The fourth water-passing container:

The mineral-imparting material (B4) is mixture including: 90 weight % of lime stone; 5 weight % of fossil coral; and 5 weight % of shell.

The fifth water-passing container:

The mineral-imparting material (B5) is mixture including: 80 weight % of lime stone; 10 weight % of fossil coral; and 10 weight % of shell.

The sixth water-passing container:

The mineral-imparting material (B6) is mixture including: 60 weight % of lime stone; 30 weight % of fossil coral; and 10 weight % of shell.

In the mineral-containing water (B) producing apparatus 3 of the structure of FIG. 1, the mineral-containing water (B) has been obtained by make water pass through the first through the sixth water-passing containers which use the above-mentioned mineral-imparting material (B1)-(B6), respectively.

The respective mineral-imparting material (B1)-(B6) has the same weight of 50 kg (300 kg in total). And, the amount of the circulating water has been set up at 1000 kg, and the flow velocity thereof has been also set up at 500/40 mL/s.

The mineral-containing water (A) and the mineral-containing water (B) in Example 1 produced using the above-mentioned method have been mixed according to a weight ratio of 1:10 to obtain the mineral functional water in Example 1.

Utilizing a pH meter, which is a glass electrode type hydrogen-ion density indicator “TPX-90” manufactured by Toko Chemical Laboratories, pH of the mineral functional water in Example 1 has been measured to be a pH value of 12.5.

The mineral functional water in Example 1 corresponds to mineral functional water (“CAC-717” (lot number), Tera. Protect (Trademark), and CA-C-01 (development code)) produced by Riken techno system Co., LTD.

(Evaluation of Spectral Emissivity)

An evaluation sample has been prepared by fixing the mineral functional water in Example 1 onto a ceramic carrier. And, the spectral emissivity of the sample has been measured with a far-infrared ray-radiating ratio-measuring apparatus (JIR-E500) manufactured by JEOL-Ltd.

The apparatus includes: a body of a Fourier transformed type infrared spectrophotometer (FTIR); a blackbody furnace; a sample-heating furnace; a temperature controller; and an attached optical system.

The evaluation sample with respect to spectral emissivity has been produced according to the following steps.

Based on 100 pst·wt. of ceramic powder (rock powder produced in Amakusa Ohyanoshima) for the carrier, 20 pst·wt. of the mineral functional water in Example 1 have been added to be clay.

The clay has been shaped into a flat disk having about 5 mm of thickness and 2 cm of diameter. And then, the shaped disk has been calcined at 1000 Centigrade to obtain the evaluation sample onto which mineral components contained in the sample (mineral functional water) have been fixed.

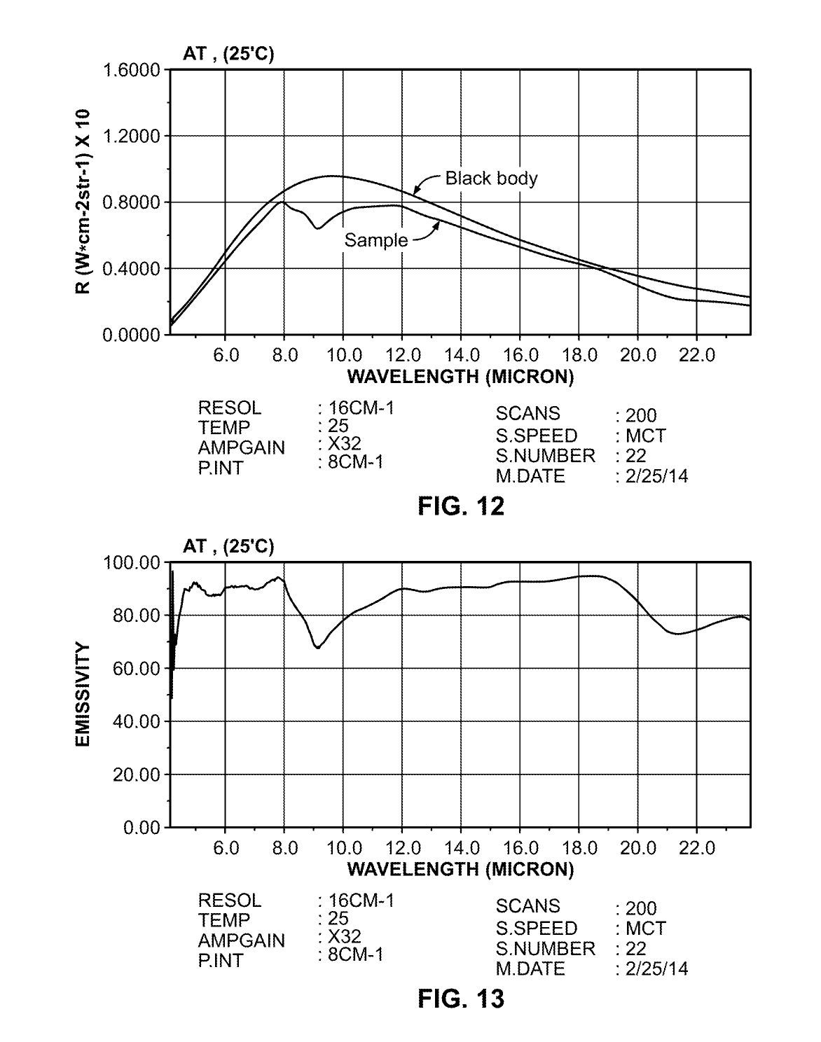

FIG. 12 shows the spectral radiation spectrum (measurement temperature: 25 Centigrade, wavelengths: 4-24 micrometers) of the mineral functional water in Example 1 fixed onto the evaluation sample.

In addition, FIG. 12 also shows the spectral radiation spectrum (theoretical value) of the black body.

In FIG. 12, scales on the vertical axis indicate the strength of radiant energy using values (Watt) per square centimeters.

It means that the closer the measured curved line of the “evaluation sample” is to the theoretical curved line of the black body, the higher radiation power the evaluation sample possesses.

FIG. 13 shows the emissivity (wavelengths: 4-24 micrometers) calculated according to the spectral radiation spectrum of the evaluation sample and the spectral radiation spectrum (theoretical value) of the black body.

Upon calculating the average emissivity between the wavelengths of 5-7 micrometers and between the wavelengths of 14-24 micrometers based on FIG. 13, it is noted that a value of 91.7% has been obtained.

### Comparative Example 1

The mineral functional water in Comparative example 1 has been obtained in the same manner as the mineral functional water in Example 1 except having replaced the raw material plant of the mineral-containing water (A) with the followings.

1. (Alternation for Comparative Examples 1)

Raw material for producing the mineral-imparting material (A) for the mineral-containing water (A)

The first altered mineral-imparting material (A) has been produced by mixing, as the vegetation raw material (A1), 20 weight % of dried Oxalis corniculata (leaf parts thereof); 20 weight % of dried Saxifraga stolonifera (leaf parts, stem parts, and flower parts thereof); 20 weight % of dried Allium tuberosum (leaf parts thereof); and mixing, as the woody plant raw material (A2), 40 weight % of dried Ginkgo biloba (leaf parts thereof).

The mineral-containing water in Comparative example 1 (A) has been obtained in the same manner as Example 1 except having used the first altered mineral-imparting material (A) for Comparative example 1.

2. Manufacturing the Mineral-Containing Water (B)

The mineral-containing water (B) has been obtained in the same manner (material, method, or the like) as Example 1.

The mineral-containing water (A) and the mineral-containing water (B) in Comparative example 1 produced using the above-mentioned method have been mixed according to a weight ratio of 1:10 to obtain the mineral functional water in Comparative example 1.

Utilizing the pH meter, pH of the mineral functional water in Comparative example 1 has been measured to be a pH value of 5.5.

With respect to the average emissivity between the wavelengths of 5-7 micrometers and between the wavelengths of 14-24 micrometers, it is noted that a value of 92.1% has been obtained.

### Comparative Example 2

The mineral functional water in Comparative example 2 has been obtained in the same manner as the mineral functional water in Example 1 except having replaced the raw material plant of the mineral-containing water (A) with the followings.

1. (Alternation for Comparative Example 2)

Raw material for producing the mineral-imparting material (A) for the mineral-containing water (A)

The second altered mineral-imparting material (A) has been produced by: mixing, as the vegetation raw material (A1), 10 weight % of dried Astemisia indica (leaf parts, and stem parts thereof); 10 weight % of dried Farfugium japonicum (leaf parts, stem parts thereof); 10 weight % of dried Kerria japonica (leaf parts, stem parts, and flower parts thereof); 10 weight % of dried Agrimonia pilosa var. japonica (leaf parts, stem parts, and flower parts thereof); 10 weight % of dried Allium tuberosum (leaf parts thereof); 10 weight % of dried Nasturtium officinale (leaf parts thereof); and mixing, as the woody plant raw material (A2), 20 weight % of dried Pinus L. (leaf parts thereof). The mineral-containing water in Comparative example 2 (A) has been obtained in the same manner as Example 1 except having used the second altered mineral-imparting material (A) for Comparative example 2.

2. Manufacturing the Mineral-Containing Water (B)

The mineral-containing water (B) has been obtained in the same manner (material, method, or the like) as Example 1.

The mineral-containing water (A) and the mineral-containing water (B) in Comparative example 2 produced using the above-mentioned method have been mixed according to a weight ratio of 1:10 to obtain the mineral functional water in Comparative example 2.

Utilizing the pH meter, pH of the mineral functional water in Comparative example 2 has been measured to be a pH value of 3.5.

With respect to the average emissivity between the wavelengths of 5-7 micrometers and between the wavelengths of 14-24 micrometers, it is noted that a value of 89.4% has been obtained.

[2. Control Test Against Unicellular Organisms]

As composition for controlling against unicellular organisms in Example 1, using an undiluted sample of the mineral functional water in Example 1, the following control test against bacteria or the like (unicellular organisms) has been made.

Evaluation 1: Staphylococcus aureus

Firstly, the test organism liquid has been produced by: using sterilized 1/500 nutrient broth medium; and preparing Staphylococcus aureus so as to have 2.5×10⁶ per mL of fungus liquid density.

Secondly, 100 mL of mineral functional water in Example 1 has been put into a sterilized triangular flask, and 1 mL of the test organism liquid has been dropped thereto, and has been placed still at the room temperature at about 25 Centigrade for one hour.

Thirdly, after one hour still standing, the solution in the triangular flask has been agitated by a hand, and has been diluted with phosphate-buffered saline, and the viable cell number per 1 mL of the sample has been measured using the pour plate culture method.

In the meantime, as a comparative (contrast) example, an example wherein 1 mL of the test organism liquid has been put into 100 mL of sterilized ion exchange water has been used.

Table 1 shows viable cell numbers per in Example 1 and the comparative (contrast) example The viable cell numbers includes: first numbers when immediately after dropping 1 mL of the test organism liquid and second numbers when one hour after that.

With respect to the comparative (contrast) example wherein does not contain the mineral functional water, difference between the first numbers and the second numbers (between immediately after the dropping and one hour after that) has been hardly recognized.

Whereas, the second numbers (one hour after that) with respect to Example 1 is nearly zero.

This result reveals that the mineral functional water in Example 1 shows remarkable controlling effects upon Staphylococcus aureus.

TABLE 1

| | | viable cell | |
|---|---|---|---|
| | | number (/mL) | |
| | | | one |
| | | | hour |
| | sample | dropping | after |
| example | mineral | 1.6 × 10⁴ | <1 |
| | functional | | |
| | water | | |
| contrast | ion | 2.3 × 10⁴ | 2.0 × 10⁴ |
| | exchange | | |
| | water | | |

Evaluation 2: Escherichia coli

(Evaluation 2-1)

Firstly, the test organism liquid has been produced by: using sterilized 1/500 nutrient broth medium; and preparing Escherichia coli so as to have 2.3×10⁶ per mL of fungus liquid density.

Secondly, 100 mL of mineral functional water in Example 1 has been put into a sterilized triangular flask, and 1 mL of the test organism liquid has been dropped thereto, and has been placed still at the room temperature at about 25 Centigrade for one hour.

Thirdly, after one hour still standing, the solution in the triangular flask has been agitated by a hand, and has been diluted with phosphate-buffered saline, and the viable cell number per 1 mL of the sample has been measured using the pour plate culture method.

In the meantime, as a comparative (contrast) example, an example wherein 1 mL of the test organism liquid has been put into 100 mL of sterilized ion exchange water has been used.

Table 2 shows viable cell numbers in Example 1 and the comparative (contrast) example. The viable cell numbers includes: first numbers when immediately after dropping 1 mL of the test organism liquid and second numbers when one hour after that.

With respect to the comparative (contrast) example wherein does not contain the mineral functional water, difference between the first numbers and the second numbers (between immediately after the dropping and one hour after that) has been hardly recognized.

Whereas, the second numbers (one hour after that) with respect to Example 1 is nearly zero.

This result reveals that the mineral functional water in Example 1 shows remarkable controlling effects upon Escherichia coli.

TABLE 2

| | | viable cell | |
|---|---|---|---|
| | | number (/mL) | |
| | | | one hour |
| | sample | dropping | after |
| example | mineral | 9.7 × 10³ | <1 |
| | functional water | | |
| contrast | ion exchange | 1.9 × 10⁴ | 2.0 × 10⁴ |
| | water | | |

(Evaluation 2-2)

The viable cell numbers have been measured according to the same method as evaluation 2-1 except having used the mineral functional water in Comparative example 1.

Measurement of the viable cell numbers have been performed immediately after the dropping, and one day, three days, and one week after that.

Table 3 shows results thereof.

Little reduction of the viable cell numbers can be recognized after one day. Escherichia coli, however, increases again to reach the numbers before inoculation after one week.

TABLE 3

| | | viable cell number (/mL) | | | |
|---|---|---|---|---|---|
| | sample | dropping | 1 day | 3 days | 1 week |
| comparative | mineral | >1.0 × 10⁶ | 1.9 × 10² | 2.5 × 10² | >1.0 × 10⁶ |
| example 1 | functional | | | | |
| | water | | | | |

Evaluation 3: Candida albicans

Control effects of the mineral functional water in Example 1 upon Candida have been evaluated in the same manner as Evaluation 1 and Evaluation 2.

Firstly, the test organism liquid has been produced by: using sterilized 1/500 nutrient broth medium; and preparing Candida so as to have 1×10⁶ per mL of fungus liquid density.

Secondly, 100 mL of mineral functional water in Example 1 has been put into a sterilized triangular flask, and 1 mL of the test organism liquid has been dropped thereto, and has been placed still at the room temperature at about 25 Centigrade for one hour.

Thirdly, after one hour still standing, the solution in the triangular flask has been agitated by a hand, and has been diluted with phosphate-buffered saline, and the viable cell number per 1 mL of the sample has been measured using the pour plate culture method.

Measurement of the viable cell numbers have been performed immediately after the dropping, and one day, three days, and one week after that.

Utilizing the mineral functional water in Comparative example 2, the same test as the above has been made.

Table 4 shows results thereof.

TABLE 4

| | | viable cell number (/mL) | | | |
|---|---|---|---|---|---|
| | sample | dropping | 1 day | 3 days | 1 week |
| example 1 | mineral | >1.0 × 10⁶ | 1.0 × 10² | <1 | <1 |
| | functional | | | | |
| | water | | | | |
| comparative | mineral | >1.0 × 10⁶ | 1.0 × 10³ | 1.0 × 10³ | >1.0 × 10⁶ |
| example 2 | functional | | | | |
| | water | | | | |

Evaluation 4: Pseudomonas aeruginosa

Control effects of the mineral functional water in Example 1 upon Pseudomonas aeruginosa has been evaluated in the same manner as Evaluation 1 and Evaluation 2.

Firstly, the test organism liquid has been produced by: using sterilized 1/500 nutrient broth medium; and preparing Candida so as to have 1×10⁶ per mL of fungus liquid density.

Secondly, 100 mL of mineral functional water in Example 1 has been put into a sterilized triangular flask, and I mL of the test organism liquid has been dropped thereto, and has been placed still at the room temperature at about 25 Centigrade for one hour.

Thirdly, after one hour still standing, the solution in the triangular flask has been agitated by a hand, and has been diluted with phosphate-buffered saline, and the viable cell number per 1 mL of the sample has been measured using the pour plate culture method.

Measurement of the viable cell numbers have been performed immediately after the dropping, and one day, three days, and one week after that.

Table 5 shows results thereof.

TABLE 5

| | | viable cell number (/mL) | | | |
|---|---|---|---|---|---|
| | sample | dropping | 1 day | 3 days | 1 week |
| example 1 | mineral | 1.0 × 10⁶ | <1 | <1 | <1 |
| | functional | | | | |
| | water | | | | |

[3. Dermatitis Reaction Test]

Diagnosis of inflammation caused by bringing the mineral functional water in Example 1 into contact with the skin of a human body has been made.

The criterion thereof has been based on the standard in 2009 (Heisei 21) (hereinafter, called as “the reference standard”) by The Executive Committee of the guideline for the contact dermatitis in The Japanese Dermatological Association.

More concretely, an enough amount of the mineral functional water in Example 1 has been applied onto the skin of an upper part of an arm, and 6 hours after that the state of the skin has been observed.

Based on overall judgment including: patch tests; visual observation; or the like, the diagnosis that disease caused by contact dermatitis and atopic dermatitis has not occurred, has been made.

In some cases, dermatitis may be caused by the skin contact with Rosaceae plants and Asteraceae plants, which are the raw material of the mineral functional water in Example 1. Dermatitis, however, is not surprisingly caused by the contact with the mineral functional water in Example 1.

[4. Virus Activity Prevention Test][Evaluation 1]

Using the mineral functional water (undiluted sample) in Example 1 as composition for controlling viruses in Example 1, an influenza virus activity inhibitory test (the hemagglutination activation method) including the following steps has been made.

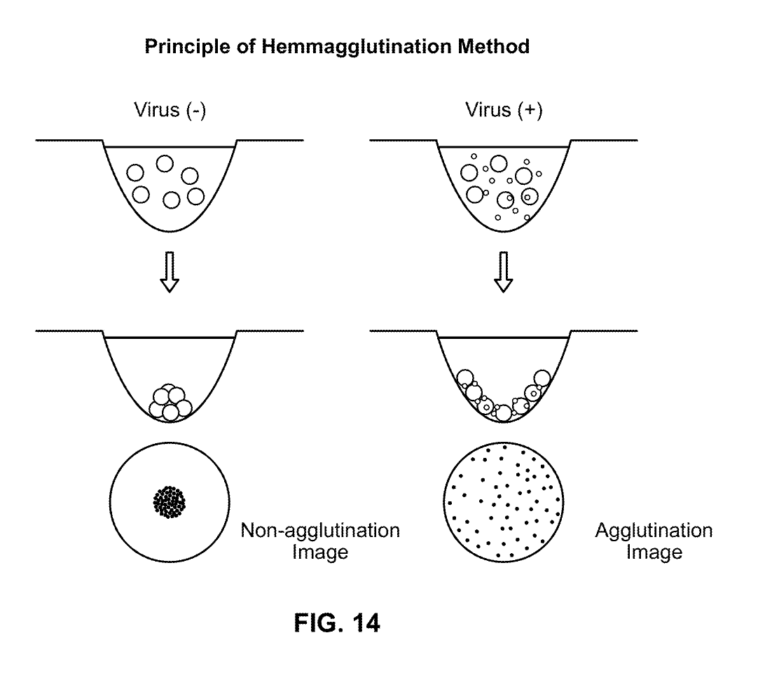

FIG. 14 is a mimetic diagram showing the principle of a hemagglutination activation method.

In FIG. 14, “agglutination” is a state, when antigenic protein existing on outer membranes of viruses (represented by influenza viruses) is activated, where the protein binds to membranes of blood cells to form a plurality of the masses of the cells, thereby the masses dispersively adhere on a surface of a micro-plate.

On the other hand, “non-aggregation” means another state where antigenic protein of influenza viruses is not activated so that the protein cannot bind to membranes of the blood cells, and the blood merely deposits as a result.

Namely, if a red center is recognized, then it is judged “non-aggregation” which means that cell infection caused by viruses is lost.

The influenza virus activity inhibitory test (the hemagglutination activation method) has been made according the following steps of:

firstly, using (i) the mineral functional water in Example 1, (ii) distilled water, and (iii) tap water, respectively, diluting purified influenza viruses (A/Memphis/1/1971 (virus type HA3_NA2 strain, hereinafter, called as “H3N2.”) 2⁷ times (128 times) to produce make three kinds (i), (ii), and (iii) of virus suspension water; and settling the respective virus suspension water for 30 minutes at room temperature;

secondly, mixing the same volume of: the respective virus suspension water; and phosphate buffered saline (PBS) of double density to form the mixture thereof; and diluting the mixture in series of double dilution of the PBS, thereby obtaining the respective diluted solution; and

thirdly, adding 0.5% PBS solution of guinea pig erythrocyte suspension to 50 micro-liters of the respective obtained solution on a micro-plate; shaking it with a plate shaker; settling it for two hours at 4 Centigrade; and after that observing the respective hemagglutination image.

As a contrast experiment, except having used the PBS instead of the mineral functional water in Example 1, evaluation of the contrast experiment has been made in the same manner as the above.

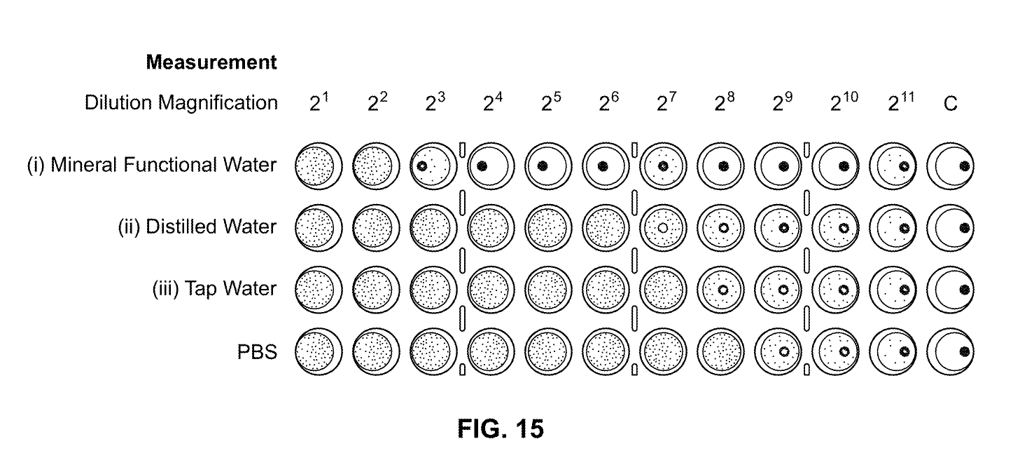

FIG. 15 shows the results of the influenza virus activity inhibitory test according to the hemagglutination activation method.

The symbol of “C” in FIG. 15 indicates the result in the case where using PBS instead of virus dilution as the negative controls there-for.

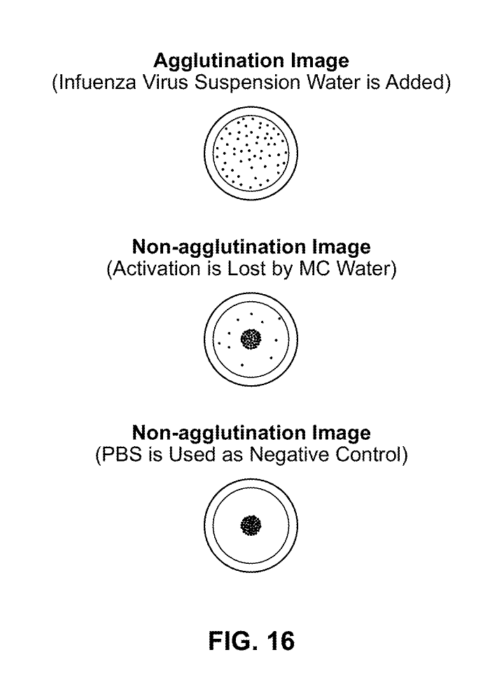

FIG. 16 shows the reference images in the influenza virus activity inhibitory test according to the hemagglutination activation method.

Table 6 shows the measurement results of the HAU test obtained based on FIG. 15.

TABLE 6

| | HA |
|---|---|
| | activity |
| mineral functional water | 2² |
| distilled water | 2⁷ |
| tap water | 2⁷ |
| PBS | 2⁸ |

The followings are clear from FIG. 15 and Table 6.

When using (i) the mineral functional water in Embodiment 1,

the hem agglutinating activity (HA activity) of vimses has been remarkably inhibited to be decreased to 1/2⁶(1/64) of HA activity when using the PBS; and

the (undiluted) sample (i) has showed 2⁵ times as high HA inhibited action as both (ii) the sample diluted by the distilled water and (iii) the sample diluted by the tap-water.

[Evaluation 2]

Using the mineral functional water (undiluted sample) in Example 1 as composition for controlling viruses in Example 1, antivirus effects upon the following viruses related to bovine respiratory diseases have been evaluated.

These viruses are of: a non-enveloped RNA-type; an enveloped RNA-type; a non-enveloped DNA-type; and an enveloped DNA-type, respectively, and correspond to models of the respective type of viruses.

Evaluation 2 has been made in order to judge to which among these four types the composition for controlling viruses in Example 1 manifests antivirus effects thereon.

(1) Virus 1:

Bovine Rhinitis B virus (Genus: Picobirnaviridae, Family: Aphthovirus) non-enveloped RNA-type

(2) Virus 2:

Parainfluenza in cattle virus (Genus: Pararnvxoviridae, Family: Respirovirus) enveloped RNA-type

(3) Virus 3:

Bovine adenovirus (Genus: Adenoviridae, Family: Adenoviridae) non-enveloped DNA-type

(4) Virus 4:

Infectious bovine rhinotracheitis virus (Genus: Ferpesviridae, Family: Varicellovirus) enveloped DNA-type

Note that Bovine Rhinitis B viruses have similar characteristics to Foot and Mouth disease viruses, each of which belong to Aphthovirus of Family Picornaviridae, and may be substitute viruses for evaluating antivirus effect upon Foot and Mouth disease viruses.

1) Inactivation Test

This has been according the following steps of:

firstly, mixing 20 micro-liters of viruses liquid and 180 micro-liters of the mineral functional water to making it act for a determined period at room temperature (25 Centigrade) to form solution; applying 100 micro-liters of the solution to sephadex LH20 having 800 micro-liters of bed volume to perform gel filtration thereon, thereby obtaining filtrate;

secondly, diluting the filtrate with MEM into ten stages; inoculating the viruses onto 96 monolayer cultures with well plates carrying cells thereon, wherein Virus 1 and Virus 2 have been inoculated into primary culture cells of calf testis, and Virus 2 and Virus 3 have been inoculated into MDBK-SY cells; making the viruses to be adsorbed therein at 37 Centigrade for one hour; and

thirdly, adding maintenance medium (2% cow fetus serum, 20mM HEPES (pH 7.2) MEM-added) to incubate it at 37 Centigrade.

Referring to an index of a cytopathic effect (CPE), the existence of viral propagation has been judged (Virus 1: after six days; Virus 2: after nine days; Virus 3: after six days; and Virus 4: after nine days) to obtain the respective virus titer (TCID 50/mL).

In a contrast test, the tap water (pH 7.2) instead of the mineral functional water and the maintenance medium has been used.

The virus inactivity action has been evaluated using the exponent difference of Log 10 based on the titer of the maintenance medium treatment in the contrast test.

Namely, the grater the value of the exponent difference is, the grater effects of the virus inactivity action are.

Table 7 shows summarized results thereof.

As the result of having contacted the mineral functional water in Example 1 with the Viruses 1-4 at room temperature, the inactivity action of: 99.8% or more against Virus 1; and 99.99% or more against Viruses 2-4 have been confirmed.

In the contrast test of tap water, no virus inactivity action has been confirmed. In view of the above, it has been confirmed that the mineral functional water in Example 1 manifests the excellent virus inactivity action against all of the four types of viruses.

Table 8 shows results of evaluating antivirus effects upon the mixture of Virus 1 and the mineral functional water as the time goes by after having mixed them.

The mineral functional water in Example 1 has showed the excellent antivirus effects from immediately after having mixed them.

TABLE 7

| | virus 1 | virus 2 | virus 3 | virus 4 |
|---|---|---|---|---|
| | non-enveloped | enveloped | non-enveloped | enveloped |
| | RNA-type | RNA-type | DNA-type | DNA-type |
| exmaple 1 | ≧2.75 | ≧4.00 | ≧4.50 | ≧5.00 |
| contrast | 0 | 0.75 | 0.50 | 0 |

TABLE 8

| | reaction time | | | |
|---|---|---|---|---|
| | 1 minute | 15 minutes | 30 minutes | 60 minutes |
| exmaple 1 | ≧2.75 | ≧2.75 | ≧2.75 | ≧2.75 |

2) Real Time PCR

In order to investigate the deactivating mechanisms of the mineral functional water according to the present invention, relationship between time progress after mixing viruses and a viral genome amount has been evaluated according to the following steps of:

firstly, mixing 20 micro-liters of virus liquid and 180 micro-liters of the mineral functional water in Example 1 to making it act for a determined period at room temperature (25 Centigrade) to form solution; adding 20 micro-liters of 1M HEPES (pH 7.2) to the solution to be neutralized;

secondly, extracting RNA using “QIAamp Viral RNA Minikit” (QIAGEN Corporation); and composing cDNA using “ReverTra Ace” (Toyobo Corporation); and

thirdly, performing real time PCR for 45 cycles using primers having setting within regions of cDNA and RNA polymerase, “SYBR Premix EX Taq” (TAKARA Corporation), and “Light Cycler” (Rochie Diagnostic Corporation).

Herein, one cycle of the real time PCR includes: thermal-denaturalization (at 95 Centigrade, for 15 seconds); annealing (at 60 Centigrade, for 30 seconds); and elongation reaction (at 72 Centigrade, for 12 seconds).

Based on a standard whose density has been well-known, genome amounts of the samples have been quantified.

Table 9 shows results thereof.

Values in Table 9 are relative values when a genome amount is assumed to be a value of “100” at one minute after process onto the maintenance medium has been completed.

As is clear from Table 9, it has been confirmed that about 90% (one minute after the mixture) and 99% or more (fifteen minutes after the mixture) of genomes have been destroyed.

TABLE 9

| | reaction time | | | |
|---|---|---|---|---|
| | 1 minute | 15 minutes | 30 minutes | 60 minutes |
| exmaple 1 | 12.4 | 10.8 | 0.3 | 0.6 |
| tap water | 121.7 | — | — | 75 |
| maintenance | 100 | — | — | 107.7 |
| medium | | | | |

The above result reveals that, regardless of acidity and alkalinity, the mineral functional water according to the present invention manifests significant antivirus effects against all of the four types of: the non-enveloped RNA-type; the enveloped RNA-type; the non-enveloped DNA-type; and the enveloped DNA-type.

It has been also suggested that the antivirus effects can be showed immediately after the water contacts with the viruses.

Furthermore, it has been also suggested that the action of the water can reach genomes inside of the viruses so as to destroy them.

### INDUSTRIAL APPLICABILITY

The mineral functional water according to the present invention manifests controlling effects upon unicellular organisms and/or viruses, and can be preferably employed in industrial fields where the effects are valuable.

1. Mineral functional water, comprising all of requirements (i), (ii), (iii), and (iv):
(i) based on 100 pst·wt. of a ceramic carrier, in a sample in which 15 pst·wt. or more of the mineral functional water has been fixed, an average emissivity (measurement temperature: 25 Centigrade) to the black body is 90% or more between wavelengths of 5-7 micrometers and between wavelengths of 14-24 micrometers;
(ii) pH of the mineral functional water is 12 or more;
(iii) controlling effects upon at least one of unicellular organisms and viruses are showed; and
(iv) carbonate components are included in the mineral functional water.

2. A controlling method of applying the mineral functional water as defined in claim 1 upon a target to be controlled including at least one of the unicellular organisms and the viruses.

3. The controlling method as defined in claim 2, wherein the target of unicellular organisms to be controlled is at least one kind selected from a group consisting of Escherichia coli, Staphylococcus aureus, Bacillus subtilis, Pseudomonas aeruginosa, Candida, O-157, Mycoplasma, and Vibrio parahaemolyticus.

4. The controlling method as defined in claim 2, wherein the target of viruses to be controlled is at least one kind selected from a group consisting of a non-enveloped RNA-type, an enveloped RNA-type, a non-enveloped DNA-type, and an enveloped DNA-type.

5. The controlling method as defined in claim 2, wherein the target of viruses to be controlled is at least one kind selected from a group consisting of Foot and Mouth disease viruses, Bovine Rhinitis B viruses, parainfluenza in cattle viruses, bovine adenoviruses, and infectious bovine rhinotracheitis viruses.

6. The controlling method as defined in claim 2, wherein the target of viruses to be controlled is at least one kind selected from a group consisting of influenza viruses, Ebola viruses, Foot and Mouth disease viruses, noroviruses, polio viruses, human immunodeficiency viruses, SARS coronaviruses, hepatitis A viruses, hepatitis C viruses, Rubella viruses, Measles viruses, Japanese encephalitis viruses, tick-borne encephalitis viruses, Rabies viruses, dengue viruses, arenaviruses, and Hantaviruses.

7. A method of using the mineral functional water as defined in claim 1 for controlling at least one of the unicellular organisms and the viruses.

8. Composition for controlling unicellular organisms and/or viruses containing the mineral functional water as defined in claim 1.

9. A method of producing mineral function water, comprising:
producing first mineral-containing water (A) according to the following first process (1):
producing second mineral-containing water (B) according to the following second process (2): and
mixing the first produced mineral-containing water (A) and the second produced mineral-containing water (B) according to a ratio within a range of 1:5-1:20 (weight ratio), wherein the first process (1) includes:
immersing a conductive wire covered with insulator and mineral-imparting material (A) into water, the mineral-imparting material containing woody plant raw material and vegetation raw material, the vegetation raw material including: vegetation belonging to Asteraceae and vegetation belonging to Rosaceae, the woody plant raw material including at least one kind selected from a group consisting of Maple, Betula platyphylla, Pinus, and Coptomeria japonica;
conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A), and
wherein the second process (2) includes:
filling up a water-passing container with inorganic mineral-imparting material (B) including 65 to 75 weight % of lime stone, 12 to 18 weight % of fossil coral, 12 to 18 weight % of shell, and 0.5 to 5 weight % of activated carbon, respectively; and
making the water pass through the water-passing container to form mineral-containing water (B).

10. The method of producing mineral function water as defined in claim 9, wherein:
10 to 15 weight % of the mineral-imparting material (A) based on the water is added; and the DC electric current conducted to the conductive wire has 0.05-0.1 A of a current value and 8000-8600 V of a voltage value, respectively.

11. The method of producing mineral function water as defined in claim 9, wherein:
the second process (2) further includes:
connecting in series six water-passing containers of: a first water-passing container; a second water-passing container; a third water-passing container; a fourth water-passing container; a fifth water-passing container; and a sixth water-passing container to compose the water-passing container; filling up the six water-passing containers with inorganic mineral-imparting material (B) having different kinds from each other; and making the water pass through the six water-passing containers to form the mineral-containing water (B),
wherein:
the mineral-imparting material (B1) filled into the first water-passing container is mixture including: 65 to 75 weight % of lime stone; 12.5 to 17.5 weight % of fossil coral; and 12.5 to 17.5 weight % of shell, respectively;
the mineral-imparting material (B2) filled into the second water-passing container is mixture including: 37 to 43 weight % of lime stone; 12.5 to 17.5 weight % of fossil coral; 37 to 43 weight % of shell, and 2.5 to 7.5 weight % of activated carbon respectively;
the mineral-imparting material (B3) filled into the third water-passing container is mixture including: 75 to 85 weight % of lime stone; 12.5 to 17.5 weight % of fossil coral; and 2.5 to 7.5 weight % of shell, respectively;
the mineral-imparting material (B4) filled into the fourth water-passing container is mixture including: 85 to 95 weight % of lime stone; 2.5 to 7.5 weight % of fossil coral; and 2.5 to 7.5 weight % of shell, respectively;
the mineral-imparting material (B5) filled into the fifth water-passing container is mixture including: 75 to 85 weight % of lime stone; 7.5 to 12.5 weight % of fossil coral; and 7.5 to 12.5 weight % of shell, respectively; and
the mineral-imparting material (B6) filled into the sixth water-passing container is mixture including: 55 to 65 weight % of lime stone; 27 to 33 weight % of fossil coral; and 7.5 to 12.5 weight % of shell, respectively.

12. The method of producing mineral function water as defined in claim 11, wherein:
the mineral-imparting material (B 1) filled into the first water-passing container is mixture including: 70 weight % of lime stone; 15 weight % of fossil coral; and 15 weight % of shell, respectively;
the mineral-imparting material (B2) filled into the second water-passing container is mixture including: 40 weight % of lime stone; 15 weight % of fossil coral; 40 weight % of shell; and 5 weight % of activated carbon, respectively;
the mineral-imparting material (B3) filled into the third water-passing container is mixture including: 80 weight % of lime stone; 15 weight % of fossil coral; and 5 weight % of shell, respectively;
the mineral-imparting material (B4) filled into the fourth water-passing container is mixture including: 90 weight % of lime stone; 5 weight % of fossil coral; and 5 weight % of shell, respectively;
the mineral-imparting material (B5) filled into the fifth water-passing container is mixture including: 80 weight % of lime stone; 10 weight % of fossil coral; and 10 weight % of shell, respectively; and
the mineral-imparting material (B6) filled into the sixth water-passing container is mixture including: 60 weight % of lime stone; 30 weight % of fossil coral; and 10 weight % of shell, respectively.

13. The method of producing mineral function water as defined in claim 9, wherein:
dried pulverized product of Asteraceae plants and dried pulverized product of Rosaceae plants are used as the mineral-imparting material (A);
the dried pulverized product of the Asteraceae plants is produced by:
mixing 8 to 12 weight % of Cirsium japonicum (leaf parts, stem parts and flower parts thereof), 55 to 65 weight % of Artemisia indica (leaf parts and stem parts thereof) and 27 to 33 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 17 to 23 weight % of Rosa multiflora (leaf parts and flower parts thereof), 8 to 12 weight % of Geum japonicum (leaf parts and stem parts thereof), and 65 to 75 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:0.8 to 1:1.2 (weight ratio) to obtain vegetation raw material (A1);
the woody plant raw material (A2) is produced by:
mixing 22 to 28 weight % of Maple (leaf parts and stem parts thereof), 22 to 28 weight % of Betula platyphylla (leaf parts, stem parts, and bark parts thereof), and 45 to 55 weight % of Cryptomeria japonica (leaf parts, stem parts, and bark parts thereof) to produce third mixture; making the third mixture dry; and then pulverizing the dried third mixture; and
mineral-imparting material (A′) is obtained by mixing the vegetation raw material (A1) and the woody plant raw material (A2) according to 1:2.7 to 1:3.3 (weight ratio).

14. The method of producing mineral function water as defined in claim 13, wherein the first produced mineral-containing water (A) and the second produced mineral-containing water (B) are mixed according to a ratio within a range of 1:7-1:12 (weight ratio).

15. A method of controlling a barn, comprising: spraying the mineral functional water as defined in claim 1 in a state of mist in a space of the barn.

16. Mineral function water, containing first mineral-containing water (A) produced according to the following first process (1): and second mineral-containing water (B) produced according to the following second process (2) according to a ratio within a range of 1 : 5-1 : 20 (weight ratio),
wherein the first process (1) includes:
immersing a conductive wire covered with insulator and mineral-imparting material (A) into water, the mineral-imparting material containing woody plant raw material and vegetation raw material, the vegetation raw material including: vegetation belonging to Asteraceae and vegetation belonging to Rosaceae, the woody plant raw material including at least one kind selected from a group consisting of Maple, Betula platyphylla, Pintus, and Cryptomeria japonica; conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A),
wherein: 10 to 15 weight % of the mineral-imparting material (A) based on the water is added; and the DC electric current conducted to the conductive wire has 0.05-0.1 A of a current value and 8000-8600 V of a voltage value, respectively, and
wherein: dried pulverized product of Asteraceae plants and dried pulverized product of Rosaceae plants are used as the mineral-imparting material (A);
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and
then pulverizing the dried first mixture; the dried pulverized product of the Rosaceae plants is produced by: mixing 20 weight % of Rosa multiflora (leaf parts and flower parts thereof), 10 weight % of Geum japonican (leaf parts and stem parts thereof), and 70 weight % of Ruhus L. (leaf parts, stem parts, and flower parts thereof), respectively to produce second mixture thereof; making the second mixture dry; and
then pulverizing the dried second mixture; the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica to produce third mixture; making the third mixture dry; and
then pulverizing the dried third mixture; and mineral-imparting material (A′) is obtained by mixing the vegetation raw material (A1) and the woody plant raw material (A2) according to 1:3 (weight ratio),
wherein the second process (2) includes:
connecting in series six water-passing containers of: a first water-passing container; a second water-passing container; a third water-passing container; a fourth water-passing container; a fifth water-passing container; and a sixth water-passing container to compose the water-passing container;
filling up the six water-passing containers with inorganic mineral-imparting material (B) having different kinds from each other, and
wherein: the mineral-imparting material (B1) filled into the first water-passing container is mixture including: 70 weight % of lime stone; 15 weight % of fossil coral; and 15 weight % of shell, respectively; the mineral-imparting material (B2) filled into the second water-passing container is mixture including: 40 weight % of lime stone; 15 weight % of fossil coral; 40 weight % of shell; and 5 weight % of activated carbon, respectively; the mineral-imparting material (B3) filled into the third water-passing container is mixture including: 80 weight % of lime stone; 15 weight % of fossil coral; and 5 weight % of shell, respectively; the mineral-imparting material (B4) filled into the fourth water-passing container is mixture including: 90 weight % of lime stone; 5 weight % of fossil coral; and 5 weight % of shell, respectively; the mineral-imparting material (B5) filled into the fifth water-passing container is mixture including: 80 weight % of lime stone; 10 weight % of fossil coral; and 10 weight % of shell, respectively; and the mineral-imparting material (B6) filled into the sixth water-passing container is mixture including: 60 weight % of lime stone; 30 weight % of fossil coral; and 10 weight % of shell, respectively.

17. The mineral function water as defined in claim 16, wherein the first produced mineral-containing water (A) and the second produced mineral-containing water (B) are mixed according to a ratio of 1:10 (weight ratio).
